(19) United States
(12) Patent Application Publication
(10) Pub. No.: US 2005/0093713 A1
(43) Pub. Date: May 5, 2005

(54) Devices for three dimensional imaging and recording

(76) Inventor: Gregory Michael Orme, Tarragindi (AU)

Correspondence Address: Gregory Michael Orme, 310 Oakwood Love, Lavergne, TN, 37086-4130, US

(21) Appl. No.: 10/959,471

(22) Filed: Oct. 7, 2004

Related U.S. Application Data
(63) Continuation of application No. 09/514,031, filed on Feb. 25, 2000.

(30) Foreign Application Priority Data
Aug. 26, 1998 (WO) PCT/AU98/00679
Aug. 27, 1997 (AU) P08842
Aug. 27, 1997 (AU) AU1997PO08842

(51) Int. Cl. G08B 5/00

(52) U.S. Cl. 340/815.4; 435/419; 340/691.6

(57) ABSTRACT

A device for transmitting a 3D image, the device having a converter for converting 2D image signals representing a 3D image into image signals representing a 3D image, a transmitter means for transmitting 2D image signals to the converter and the converter in use being adapted to emit the image signals representing a 3D image whereby an observer is able to observe a 3D image represented by the image signals.

### FIELD OF THE INVENTION

The present invention relates to devices for displaying a three dimensional image.

### BACKGROUND OF THE INVENTION

Present technology enables images to be recorded in two dimensions and to be retransmitted for viewing in two dimensions, thus a television program or a film can be viewed by an observer but with a drawback that what is being seen is not an actual true representation of the original image that was recorded for transmission.

It would be desirable to record images on a recording medium such as a film so that an observer can watch the film and see 3D images. previously this has been tried by recording 3D images for example on a film using two different cameras. The film which is used to record the 3D images thus stores effectively two different sets of images of the same thing. An observer is then able to watch the film wearing special glasses which have lenses which are only able to allow transmission of images of one of the two sets of images that are recorded on the film. Because each lens allows transmission of a different one of the recorded images the observer's eyes also see different images and this creates the impression of viewing a 3D image.

The problem with the above method of viewing a 3D image is two fold. Firstly the image that is recorded on the film must be recorded by two separate cameras and thus requires twice as much memory space on the film itself and secondly it requires the observer to wear special glasses to see the 3D image that is transmitted from the film.

The present invention is aimed at providing an alternative to the above described conventional method of viewing 3D images.

### SUMMARY OF THE INVENTION

According to one aspect of the present invention there is provided a device for transmitting a 3D image. The device having a converter for converting 2D image signals into image signals representing a 3D image, a transmitter means for transmitting 2D image signals to the converter and the converter in use being adapted to emit the image signals representing a 3D image whereby an observer is able to observe a 3D image represented by the image signals.

It is preferred that the converter includes a screen from which the image signals representing a 3D image are able to be emitted.

Preferably the screen includes an outer surface having a predetermined 3 dimensional topography.

The converter may include wave means for receiving 2D image signals and emitting the 2D image signals from the outer surface as a plurality of image signals in directions corresponding to lines radiating perpendicular to a surface having a 3 dimensional configuration with a periodic pattern of peaks and troughs.

It is preferred that the converter includes wave means for receiving 2D image signals and emitting the 2D image signals from the outer surface as a plurality of multi directional image signals together forming a periodic wave pattern.

It is preferred that each of the multi-directional image signals radiates from the outer surface in a direction corresponding to part of a travelling wave front of a periodic waveform.

It is preferred that the above periodic wave front is considered to travel at right angles away from the outer surface.

The wave means preferably receives the 2D image signals and emits the 2D image signals in a periodic wave configuration from the outer surface.

The wave means preferably receives the 2D image signals and emits them at reoriented angles representative of a 3D wave pattern.

The converter may convert the 2D image signals representing a 3D image to signals travelling in a plurality of different directions so as to simulate a travelling periodic waveform, whereby an observer sees a 3D image emitted from the converter.

The outer surface of the converter may include a plurality of image emitters hereinafter called icons each for emitting 3D image signals which individually represent part of a 3D image.

The icons together preferably emit 3D image signals which together represent a whole 3D image.

It is preferred that the device is responsive to changing 2D image signals and is able to emit corresponding 3D image signals which change over a predetermined time period whereby a moving image is able to be observed by an observer.

It is preferred that the icons are evenly distributed over an emitter surface of the converter.

It is preferred that the screen has its outer surface as the emitter surface.

The icons are preferably adapted to emit image signals in a 3D radial pattern.

According to another embodiment the icons are adapted to emit image signals in a 3D arcuate pattern.

It is preferred that the icons comprise portions of a surface having a 3D topography, for example a bump, protrusion, trough or recess preferably with a curved outer or inner face.

It is preferred that the icons are physical components having a predetermined geometrical shape which is able to change the direction of image signals passing therethrough.

Each icon preferably has a part hemispherical shape.

Each icon preferably has an arcuate outer face.

It is preferred that the arcuate outer face is concave or convex.

According to one embodiment the icons have a plurality of radial holes extending therethrough.

The radial holes preferably all radiate from a virtual geometrical centre of the icon.

It is preferred that each icon has a part hemispherical outer face with a bottom face which is planar.

It is preferred that each icon comprises a convex shaped object with radial tubes extending therethrough between a lower surface and the outer surface.

It is preferred that the outer face of each icon corresponds to an output face and the lower surface or back face corresponds to an input face.

It is preferred that image signals pass from the input face to the output face and radiate from the output face in directions dictated by the surface profile of the icon.

It is preferred that the tubes have a common virtual origin located below the lower surface.

The icons preferably each have a planar lower surface which corresponds to a cord of a spherical outer surface.

Preferably an image signal emitting means is located at the bottom of each tube for directing the image signal along the tube and out from the outer end of the tube.

Each image signal emitting means is preferably referred to as a pixel.

Each pixel may be able to generate electromagnetic signals of different frequencies.

It is preferred that each pixel is able to emit either electromagnetic radiation, acoustic radiation, pressure waves, data or any other form of radiation.

Each tube preferably extends at right angles to the outer surface of the icon.

The device preferably comprises a screen surface having icons evenly spread thereover.

The screen surface may be planar, curved, contoured and may even be any irregular shaped screen surface.

In general the screen may be in the form of a sheet of material formed into any desired shape. For example the screen may be formed into the inner surface of a cylinder so that it is like a tube. It may be concave or convex and it may be adhered to any surface.

It is preferred that the screen comprises a matrix of icons which either protrude beyond a planar backing surface or are recessed below a planar backing surface but wherein the planar backing surface and the surfaces of the icons together constitute an outer surface of the converter.

The device may include a screen having the outer surface thereon.

Preferably the screen comprises an array of icons.

The icons may be arranged in rows and columns.

Each icon preferably emits a plurality of colour signals such as red, green and blue.

Preferably each icon emits signals which are representative of part of a 3D image.

It is preferred that the outer surface has a 3D configuration of peaks and troughs spread thereover.

The outer surface may have a 3D waveform configuration.

The converter preferably comprises pixels which are able to emit image signals at angles from 0 to 180° with respect to a planar base surface.

It is preferred that each pixel emits image signals as a wavefront of signals.

It is preferred that each pixel emits image signals in a radial pattern from the outer surface.

According to another aspect of the present invention a device is provided for storing and emitting a 3D image the device including a receiver for receiving 3D image signals representing a 3D image and storing the 3D image signals, a transmitter for emitting 2D image signals of the stored 3D image, a converter for converting the 2D image signals into multidirectional image signals representing the 3D image and for emitting the multidirectional image signals whereby an observer viewing the 3D image signals sees the 3D image represented by the multidirectional image signals.

It is preferred that the receiver comprises a film or storage medium.

The transmitter preferably transmits stored 3D image signals through transmission means to the converter.

The transmission means preferably comprises electrical wires or optical fibres.

It is preferred that the transmission means is located at a distance from the converter.

The receiving means may be in the form of ccd's, cameras or lens.

According to another aspect of the present invention there is provided a device for converting a 2D image to a 3D image, the device comprising an input surface, an output surface, the input surface being adapted to receive image signals representing a 2D image, the transmitter being adapted to transmit the image signals to a converter of the device and the converter being adapted to emit the image signals from the output surface whereby an observer is able to see the emitted image signals as a 3D image.

It is preferred that an observer is able to see the 3D image due to each eye seeing different image signals.

The output surface may have a surface configuration representing a 3D waveform.

The converter preferably comprises a plurality of transmission paths arranged together in a 3D waveform pattern.

Preferably the converter comprises a screen with the output surface having a thickness length and width.

The screen is preferably adapted to be located between a 2D image and an observer.

The screen may be remote from the observer.

The converter preferably comprises refraction means for refracting 2D image signals.

The refraction means preferably is part of the screen which is in the form of a layer having an evenly distributed array of convex and concave surfaces or peaks and troughs.

It is preferred that the plurality of paths correspond to the path travelled by refracted 2D image signals after striking the refraction means.

According to one embodiment of the invention the screen has an input surface with a surface configuration representing a 3D waveform or has a topography of peaks and troughs or concave and convex regions occurring evenly over the surface.

According to one embodiment the screen has a relatively small width and has a general shape approximating a 3D waveform or has a series of peaks and troughs.

It is preferred that the input surface is adapted to change the direction of the image signals so that they radiate from the outer surface in accordance with a wave pattern.

The converter screen preferably has a predetermined shape comprising a planar member having a wave like configuration.

The screen may be flat, curved, planar, circular, semi-circular or irregular.

According to one embodiment the screen is in the form of a wall or barrier through which 2D image signals are able to pass and be redirected.

It is preferred that the screen has a wave like topography on opposing surfaces thereof.

A preferred embodiment of the present invention will now be described by way of example only with reference to the accompanying drawings in which:

### BRIEF DESCRIPTION OF THE DRAWINGS

FIG. 1 shows a viewing screen;

FIG. 2 shows a profile of a surface of the viewing screen according to one embodiment;

FIG. 3 shows a surface profile of the screen according to a second embodiment;

FIG. 4 shows a surface profile of the screen according to a third embodiment;

FIG. 5 shows a conceptual diagram of a surface profile of the screen shown in FIG. 2;

FIG. 6 shows a conceptual diagram of the screen shown in FIG. 1;

FIG. 7 shows an icon of the screen according to a first embodiment;

FIG. 8 shows an icon of the screen according to a second embodiment;

FIG. 9 shows an icon of the screen according to a third embodiment;

FIG. 10 shows icons of the screen according to a fourth embodiment;

FIG. 11 shows icons of the screen according to a fifth embodiment;

FIG. 12 shows an application of the screen according to a first embodiment of the invention;

FIG. 13 shows a film according to a first embodiment of the invention;

FIG. 14 shows a top view of an icon of the present invention according to a sixth embodiment of the invention;

FIG. 15 shows a side view of the icon shown in FIG. 14;

FIG. 16 shows a top view of the icon shown in FIG. 15;

FIG. 17 shows a side view of the icon shown in FIG. 16;

FIG. 18 shows a screen having icons as shown in FIG. 17;

FIG. 19 shows a box with a screen as shown in FIG. 18;

FIG. 20 shows a detailed view of the screen shown in FIG. 18;

FIG. 21 shows a film used with the screen in FIG. 20;

FIG. 22 shows a top view of a screen with three icons each having a red, green and blue charge coupled device;

FIG. 23 shows a cathode ray tube application of a screen according to the present invention;

FIG. 24 shows a detailed view of the screen shown in FIG. 23;

FIG. 25 shows a schematic diagram of a sphere incorporating icons in accordance with the present invention;

FIG. 26 shows details of icons used for the sphere shown in FIG. 25;

FIG. 27 shows alternative icons for use with the sphere shown in FIG. 25;

FIG. 28 shows a schematic diagram of a dampening device application of the invention;

FIG. 29 shows a recording application of a screen according to the present invention;

FIG. 30 shows a top view of the device shown in FIG. 29;

FIG. 31 shows a play back option of the device shown in FIGS. 29 and 30;

FIG. 32 shows a memory device in accordance with the present invention;

FIG. 33 shows a computer application of the memory device shown in FIG. 32;

FIG. 34 shows a schematic diagram for use in understanding the storage device shown in FIG. 33;

FIG. 35 shows a further schematic diagram of the storage device shown in FIG. 33;

FIG. 36 shows a spherical screen according to the present invention;

FIG. 37 shows nodes of the spherical screen shown in FIG. 36;

FIG. 38 shows a diagrammatical representation of a node and part of a spherical screen shown in FIG. 36;

FIGS. 39A and 39B show schematic diagrams of nodes viewed by different viewers;

FIG. 40A shows a sphere designed as a cloaking device;

FIG. 40B shows coloured dots of the device shown in FIG. 40A;

FIG. 40C shows polarised transparent glasses of the device shown in FIG. 40A;

FIG. 40D shows a different orientation of the polarised transparent glasses shown in FIG. 40C;

FIG. 40E shows another orientation of the glasses shown in FIG. 40C;

FIG. 40F shows an internal ring embodiment of the device shown in FIG. 40A;

FIGS. 41A to 41E show different embodiments of a screen according to the present invention.

### DETAILED DESCRIPTION OF THE DRAWINGS

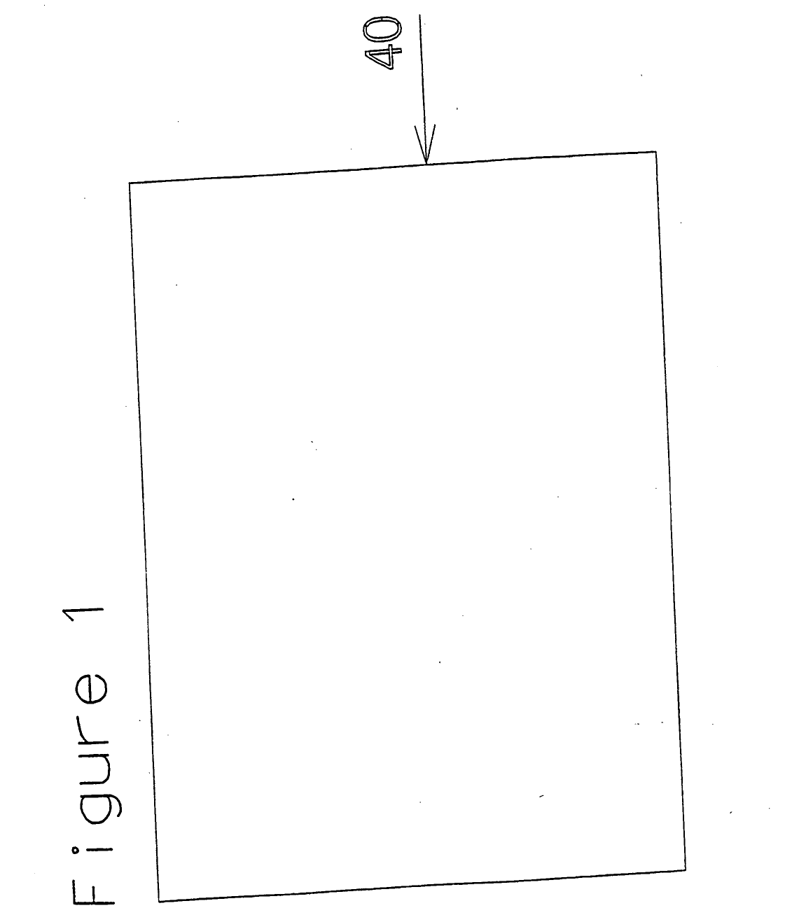

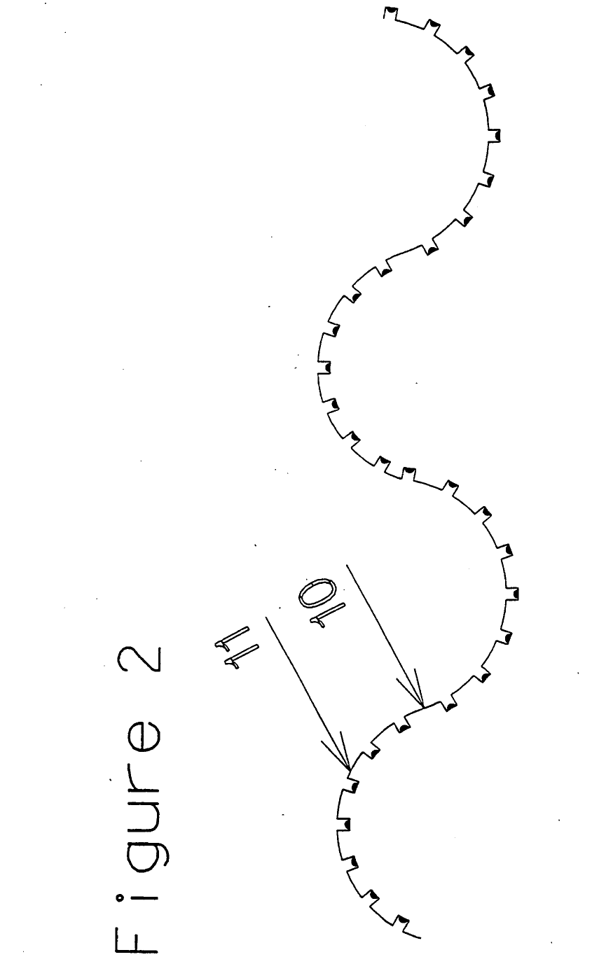

An example of a rectangular viewing screen is shown in FIG. 1. The screen is a rectangular laminella structure with a top face having a sine wave configuration. Icons 11 are shown in FIG. 2 along the surface of the screen 10.

The icons 11 are shown evenly spaced along the surface of the screen 10 but in actual fact would occur in much greater numbers and over the entire face of the rectangular screen 10.

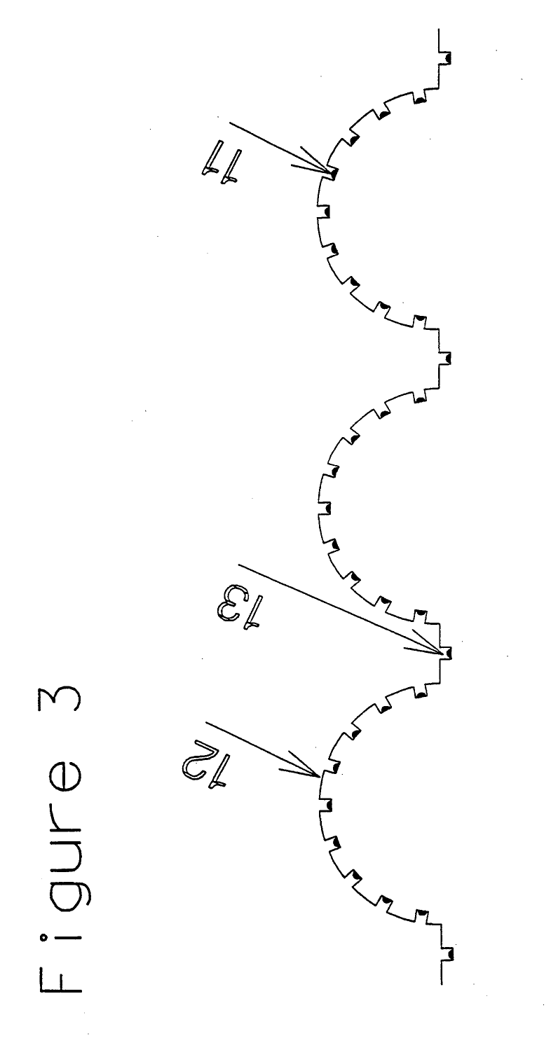

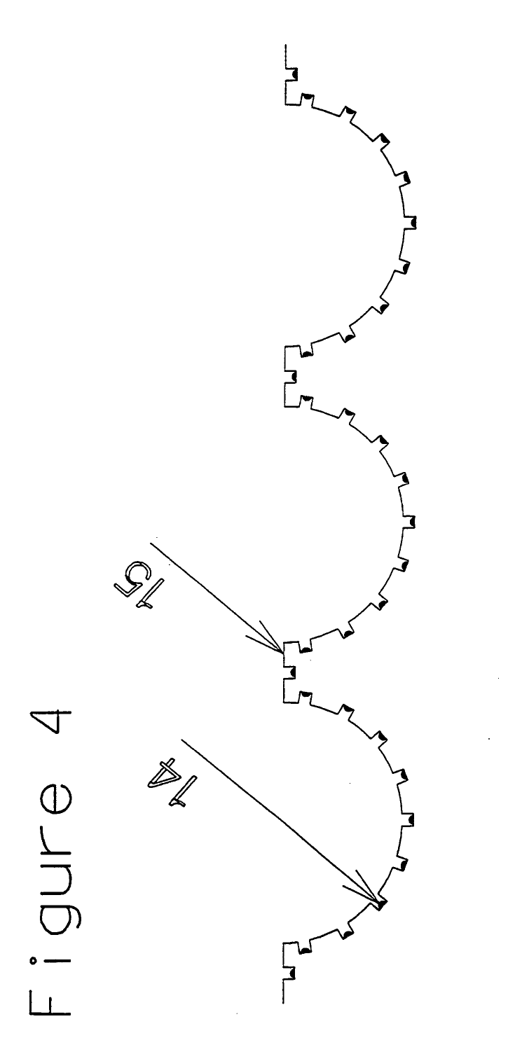

FIG. 3 shows an alternative possibility for the shape of the top surface of the screen 10 in which the wave like configuration consists of a series of semi-circular bumps 12 separated by flat surfaces 13. In FIG. 4 the wave like surface configuration is shown as a series of arcuate valleys 14 which are separated by flat surfaces 15.

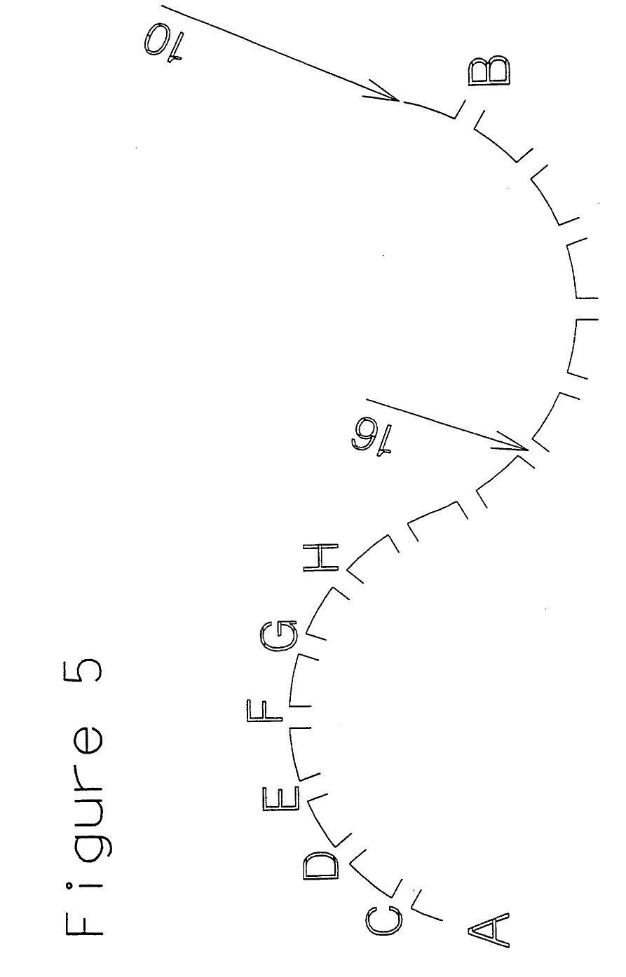

FIG. 5 shows a theoretical representation of the wave like upper surface of the screen 10.

Each of the icons are represented by tubes 16 which extend at right angles downwardly from the upper surface of the wave like surface 10. Each of the tubes 16 is oriented slightly differently from an adjacent one depending on its location on the outer surface of the screen 10.

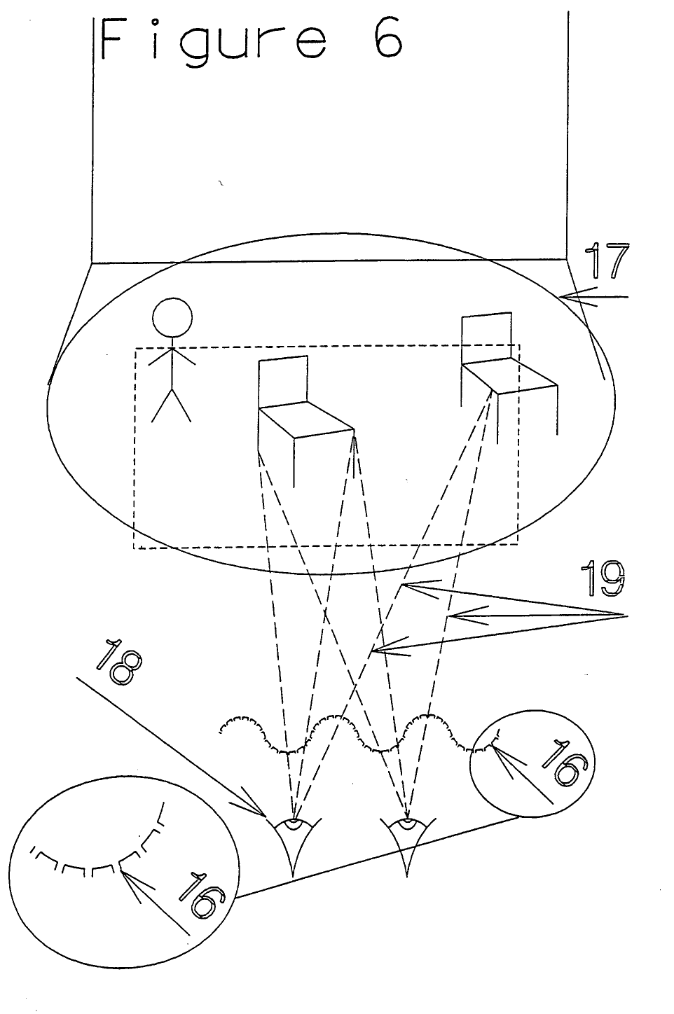

As shown in FIG. 6 each of the tubes 16 represent a path along which light is allowed to travel. Consequently as shown in FIG. 6 an image showing a scene in a room 17 is seen by a pair of eyes as image signals 19 passing through those tubes 16 which are oriented so that the eyes are able to see the image signals. Because the eyes 18 are separated in distance they each see different image signals which have passed through different tubes 16.

Because the tubes depending on their location give a line of sight anywhere to any angle no matter which way you look through the screen you can see the chair with both eyes from slightly different angles giving you depth, field and a 3D picture. If you move and look through the screen from all possible angles you will be able to see every object on the other side of the screen in perfect 3D because at all angles your sight from each eye with its unique perspective is completely unobstructed.

Everything that is able to be seen through the tubes can be simulated by putting a light in each tube, emitting the same colour and brightness that was seen through the empty tubes as shown in FIG. 6. It would also be possible to place smaller tubes within each tube three smaller tubes, for example red, green and blue so that in the right combination they can recreate any colour and intensity that was seen through that tube before, thus as an example if you were to look through a particular tube you would be able to see a certain frequency and brightness of light. Thus by placing a small light source at the bottom of each tube it should be impossible to distinguish between whether you are seeing the light source or the unobstructed view through the tube. If you then place a light source in each tube then from any angle you should be unable to tell whether you are looking at the light coming through any and all tubes or the light source placed in them.

Since you are seeing exactly the same thing you must then be looking at a 3D picture when you have light sources in each of the tubes 16. If you were looking at moving scenery as in FIG. 6 such as someone moving the chairs shown in FIG. 6, and you programmed the light source in each tube to change exactly as the view through each tube would change then you would see a 3D movie of the chairs being moved.

In a 2D photo each eye sees exactly the same picture, but because both eyes cannot see down the same tube both eyes cannot see the same picture so it must therefore be in 3D.

To take a 3D photograph or movie the principal can be applied in reverse. Just as it is possible to put a light source in each tube of the same colour and intensity as the view through the tube so it would also be possible to place film in each tube that would expose to give the same colour and intensity when developed. In this way a 3D picture faithful to the original is able to be obtained.

If one took many of these transparencies and used a device to show these transparencies in sequence we would then be able to see a 3D movie.

The concept described above by way of example gives rise to a number of different embodiments and applications. As shown the screen can be of a regular sine wave configuration or as shown in FIGS. 3 and 4 can be of an alternative wave like configuration. The waves forming the outer surface of the screen can be of any shape and size regular and irregular. The tube 16 can be of varying lengths and shapes though the number, lengths and widths of the tubes may change the sharpness and clarity of the images.

The screen itself can be flat, broken into sections, can be curved into a particular shape so that it can cover an object. Furthermore, the tubes can be of different geometrical shapes.

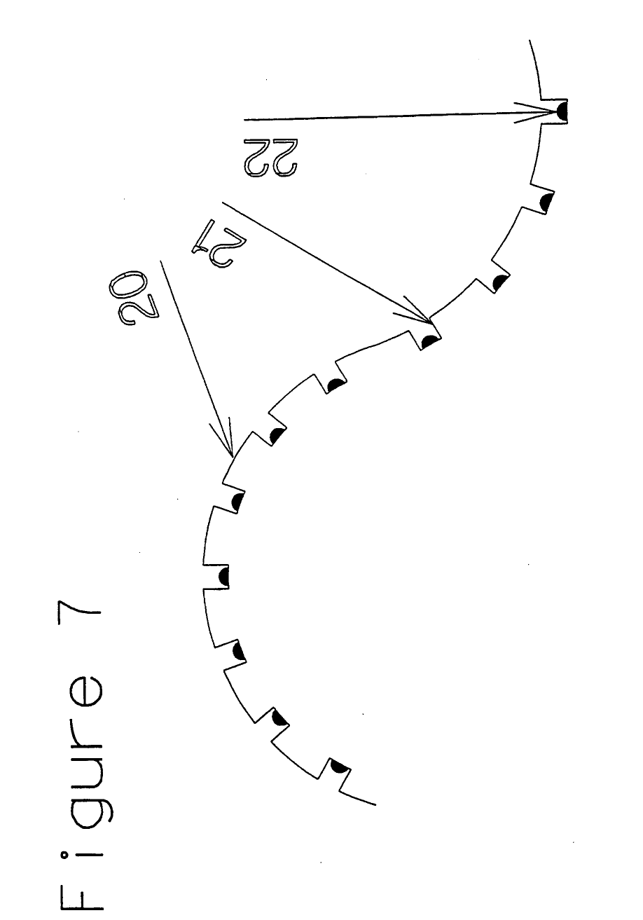

FIG. 7 shows a wave like screen surface 30 having tubes 21 extending downwardly perpendicular to the outer surface and pixels 22 located at the bottom of each tube 21. These pixels broadly represent a source of an image signal which can be a light source or any other source such as sound, pressure, magnetic etc.

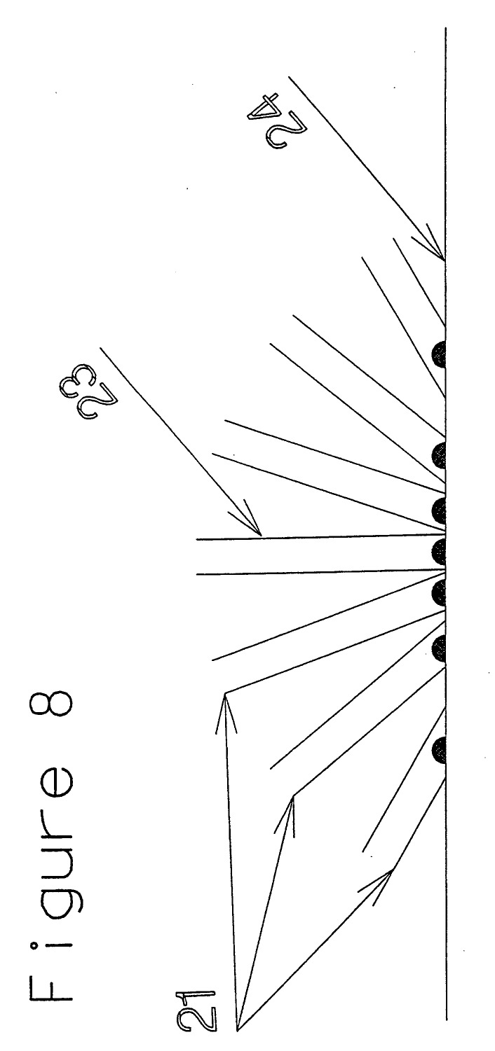

In FIG. 8 the surface of the screen has been changed by placing the tubes 21 in open space without any surface between adjacent tubes. Accordingly tubes 23 are arranged with different lengths so that the combination of each of the uppermost surfaces of the tubes 23 together form a wave-like pattern albeit one that is discontinuous. Of course because the embodiment described is conceptual in actual fact the distance between tubes would be so small as to make it impossible for a person observing the pixels at the bottom of the tubes to notice any discontinuity between adjacent pixels.

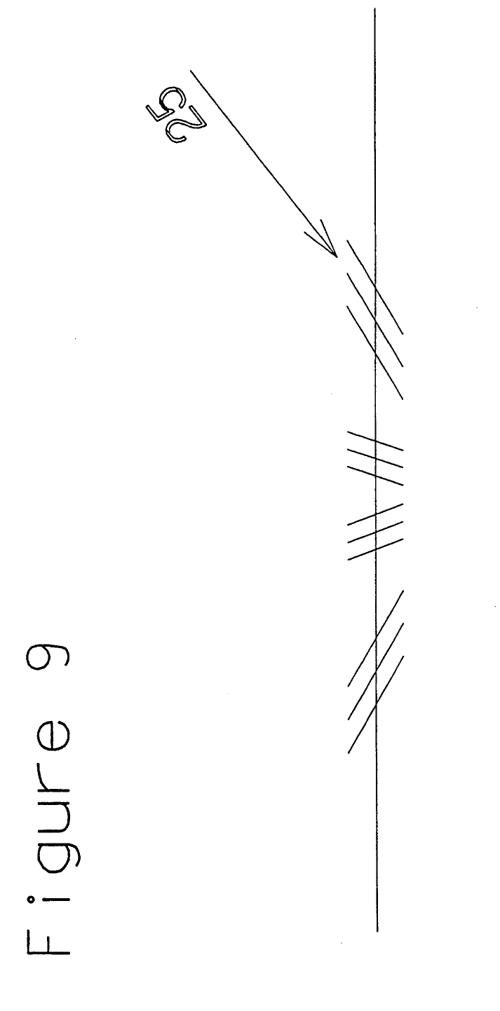

According to another variation of the invention it is possible to use polarised dots or etched surfaces as in FIG. 9 which capture light from a certain angle doing the same thing as the tubes would do.

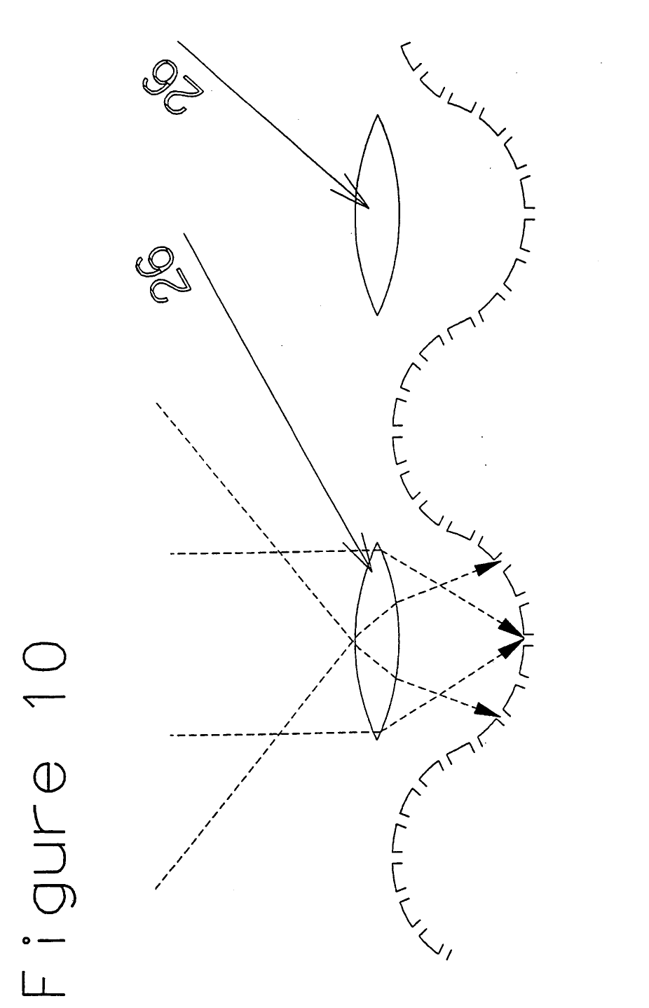

In FIG. 10 lenses 26 are provided which capture an image from each view point and record it on a curved or flat surface for some form of play back or the device can work in the reverse for transmission.

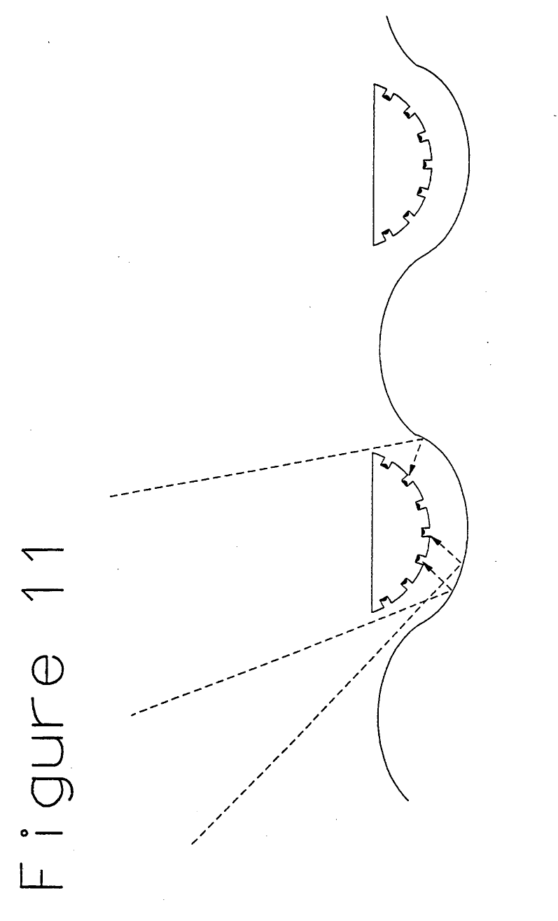

In FIG. 11 reflection instead of refraction is used to capture the images but the invention contemplates any combination of these as well.

The recording medium can be a form of film or transparency, or collectors like ccd's in a digital camera. Any form of data can be imaged such as all electromagnetic frequencies, sound waves, electrons, radar (passive and active), sonar, and positrons like in medical equipment. Even pressure or low frequency vibrations can be recorded and played back in the same or another kind or level of frequency.

An emitting device can be used to send various frequencies to an object to be reflected back. Such devices can be like an imaging screen where each pixel emits enough data as signals at certain frequencies which are able to be reflected back. This data might be radar, light, sound waves and so on.

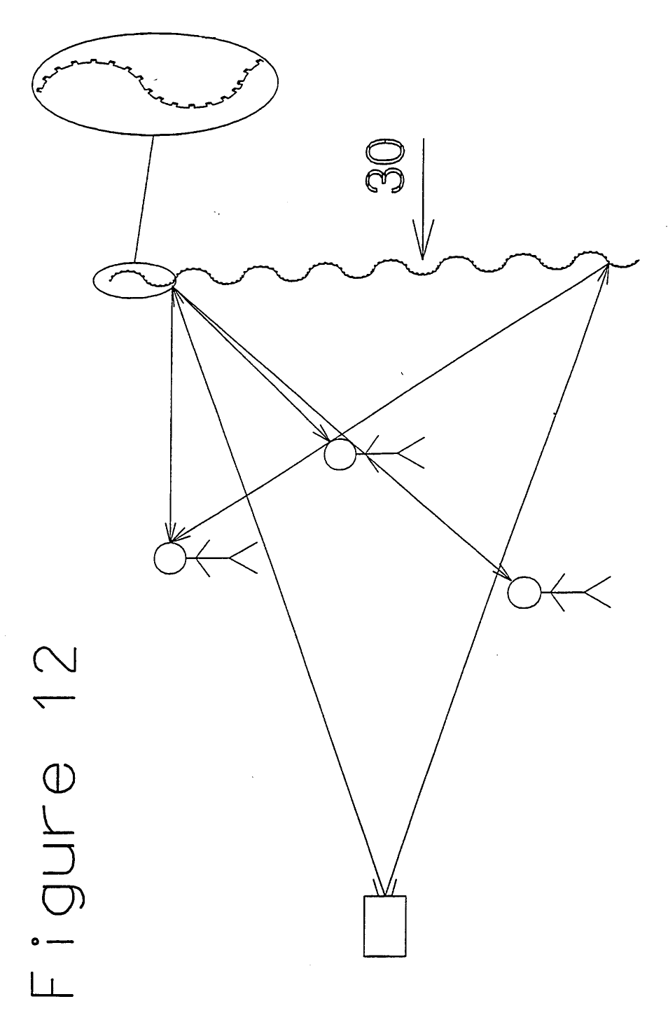

There are many forms of playback and picture generating devices. In FIG. 12 a projector or projectors shine a picture onto a screen which can have various combinations of the shapes described earlier. Each person watching the screen has a unique viewpoint and so sees a different picture to the others. Thus the screen 30 is composed of parts reflecting light such as mirrors.

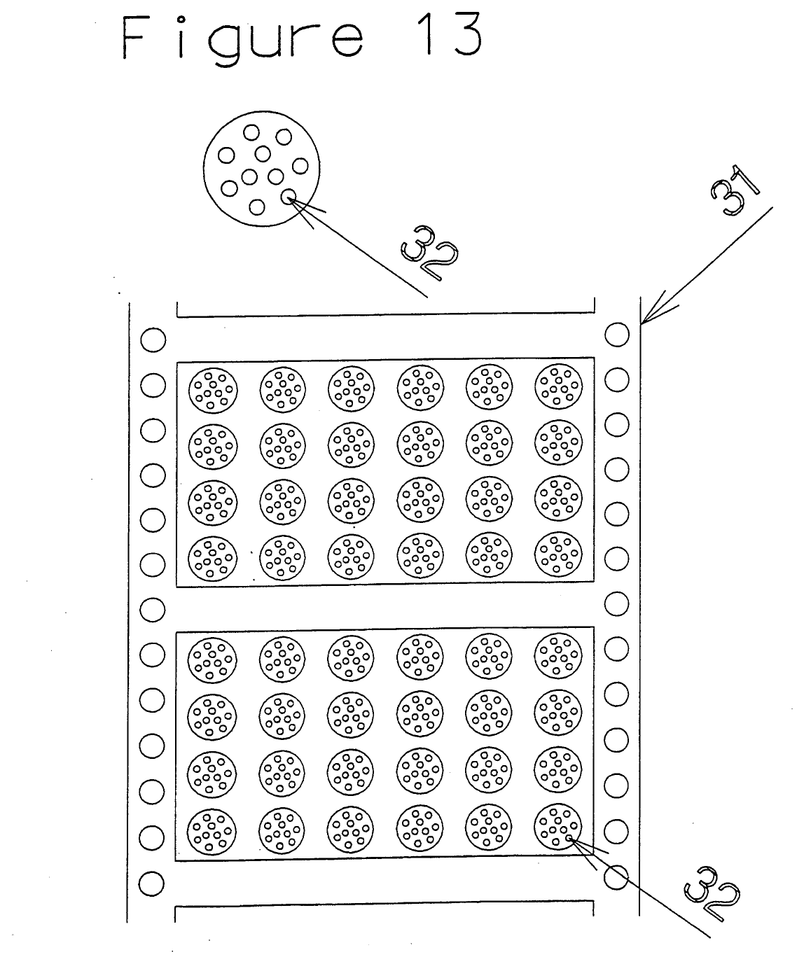

In another variation the projector in front or behind emits electromagnetic frequencies or other vibrations that stimulate or trigger each pixel to emit the correct signal. The projection device plays a film like media to shine the correct information on each pixel 32 as shown in FIG. 13 which then reflects to give the correct picture from each viewpoint. The film can be a series of pixels 32 as illustrated on the top of a film 31. The picture viewed can be a movie recorded or pictures generated in games or various computer devices and software.

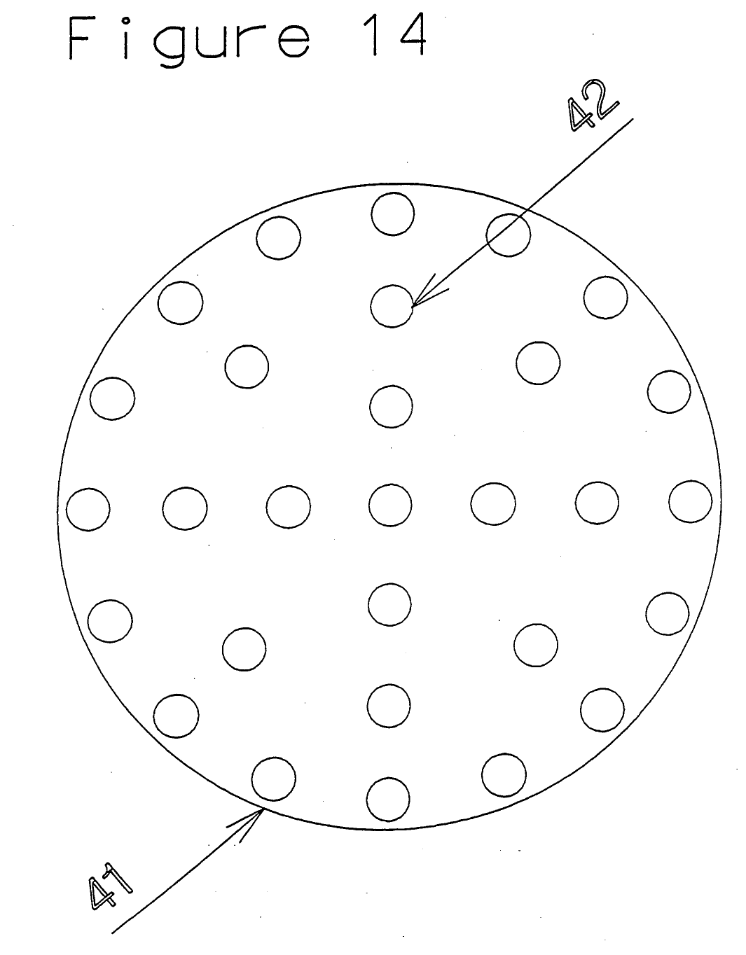

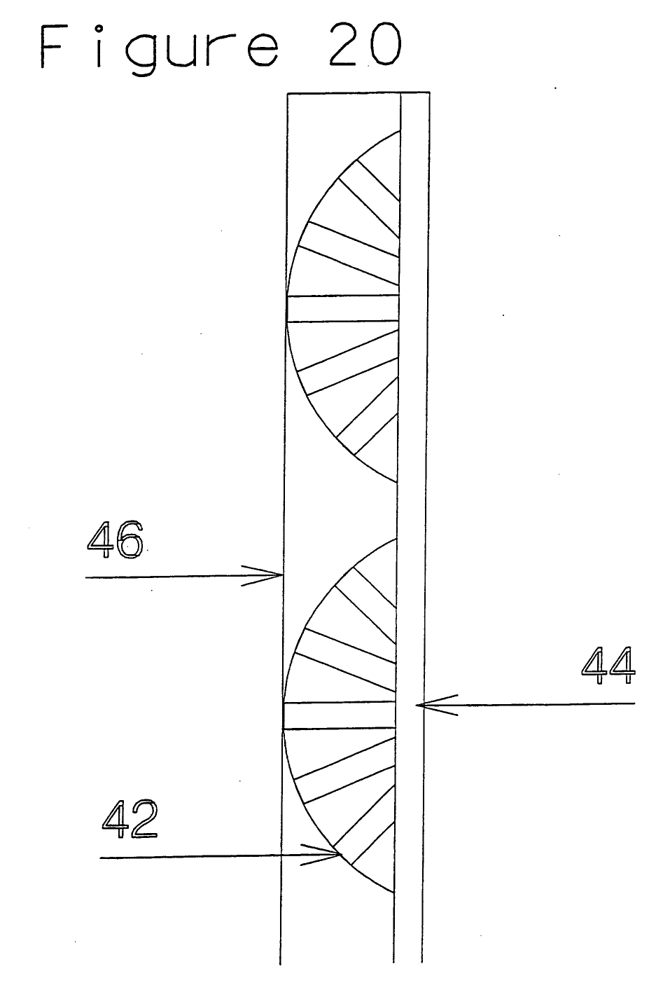

A specific example of a method of implementing the theory behind producing a 3D image as described previously is described with reference to FIGS. 14 to 21.

As previously described a screen 10, 40 can be arranged in the shape of a rectangle. The surface of the screen 40 is provided with an array of icons 41 one of which is shown in FIG. 14.

Each icon 41 is formed from a sphere which is altered in the following manner.

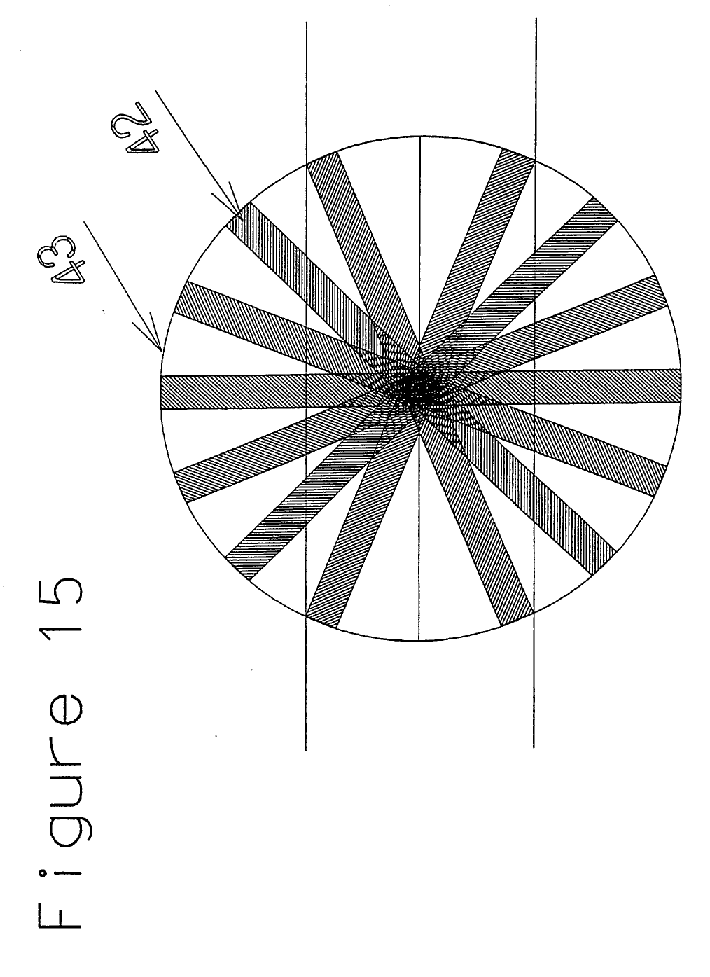

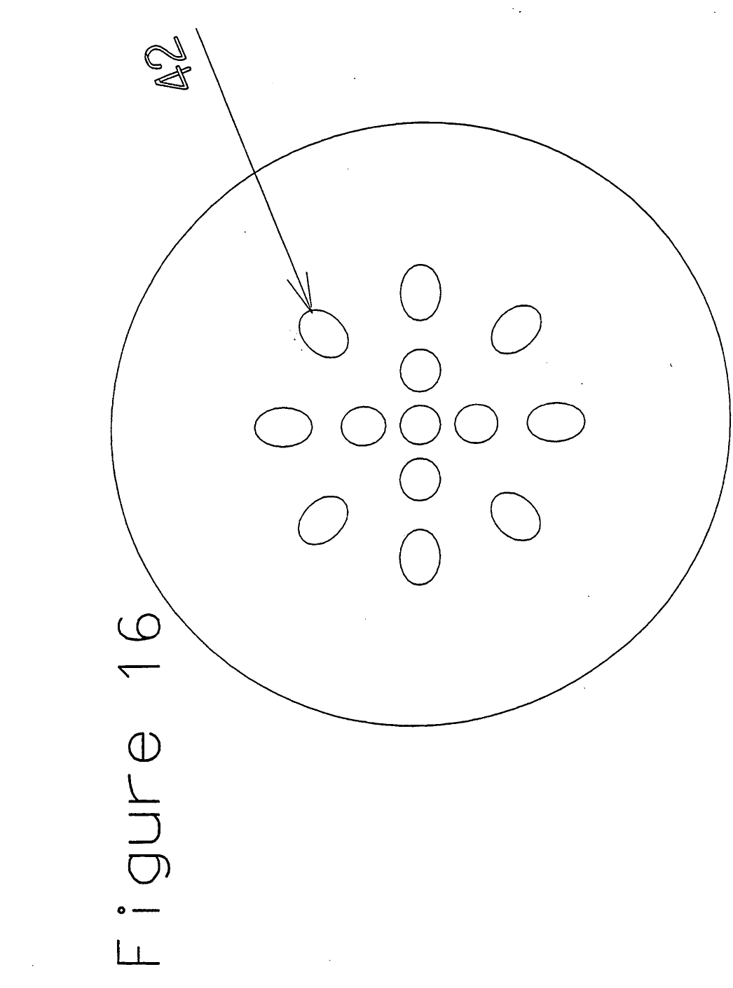

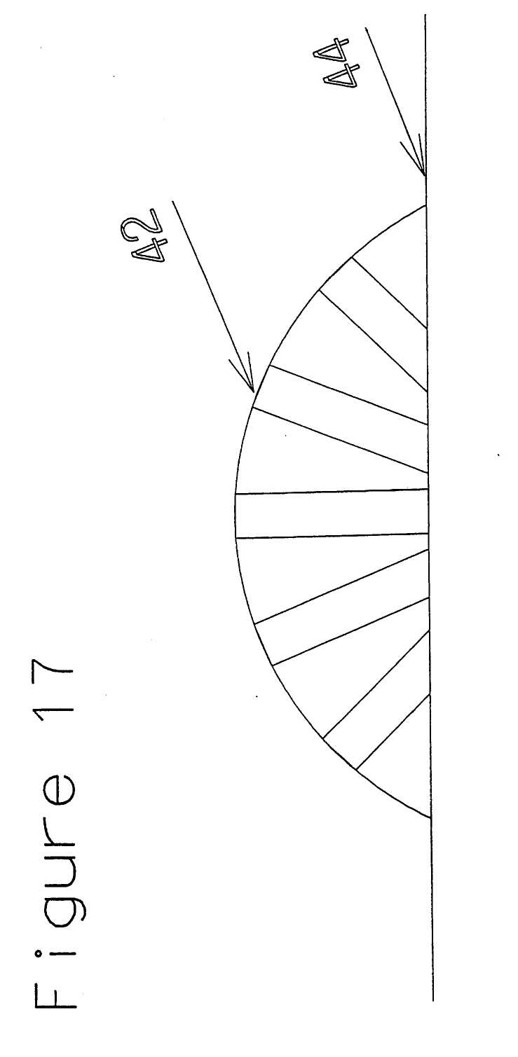

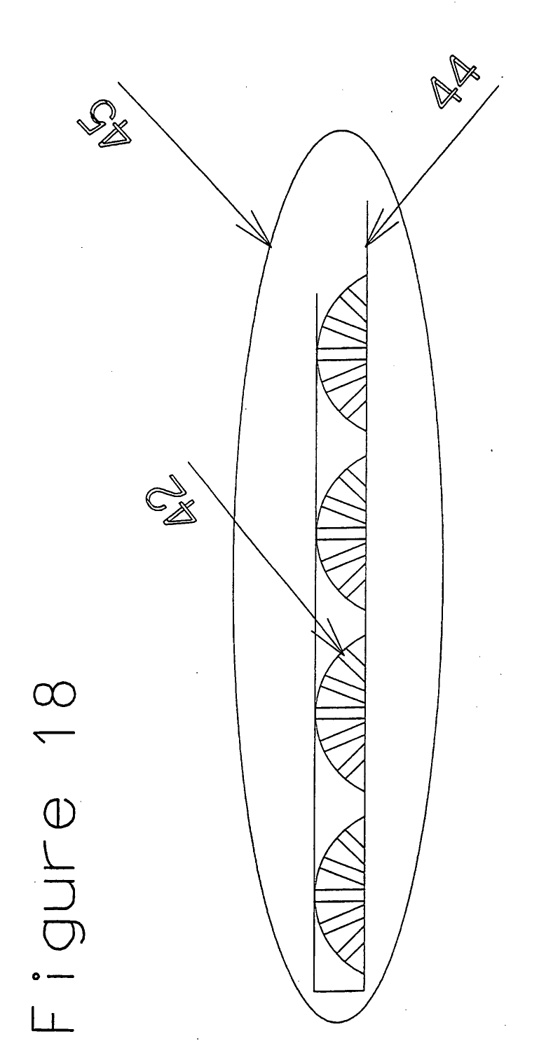

Holes 42 are made through the sphere approximately 1 mm in diameter and equidistant from each other. Each hole 42 passes through the centre of the sphere in the pattern illustrated in FIG. 15. In other words one is provided in the centre, 4 surrounding it, 8 surrounding the 4, 16 surrounding the 8 and so on until the sphere is fully covered with holes. Each hole 42 is to be approximately 3 cm further from the centre. In fact the distribution of these holes 42 is not critical as long as they are evenly spaced around the central hole. It is preferred that each of the spheres are identical and have the same orientation. Each sphere is cut in half so that the first formed hole is at right angles to the cut as shown in FIG. 15. A cut is made approximately 10 mm up the side of the hemisphere and is formed parallel to the last cut so that the piece left behind has a pattern as shown in FIG. 16. This piece is then affixed to a very thin transparent screen as shown in FIG. 17 and then the same is done to all the other spheres arranging them as shown in FIG. 18 as a series of bumps over the flat thin transparent screen 44.

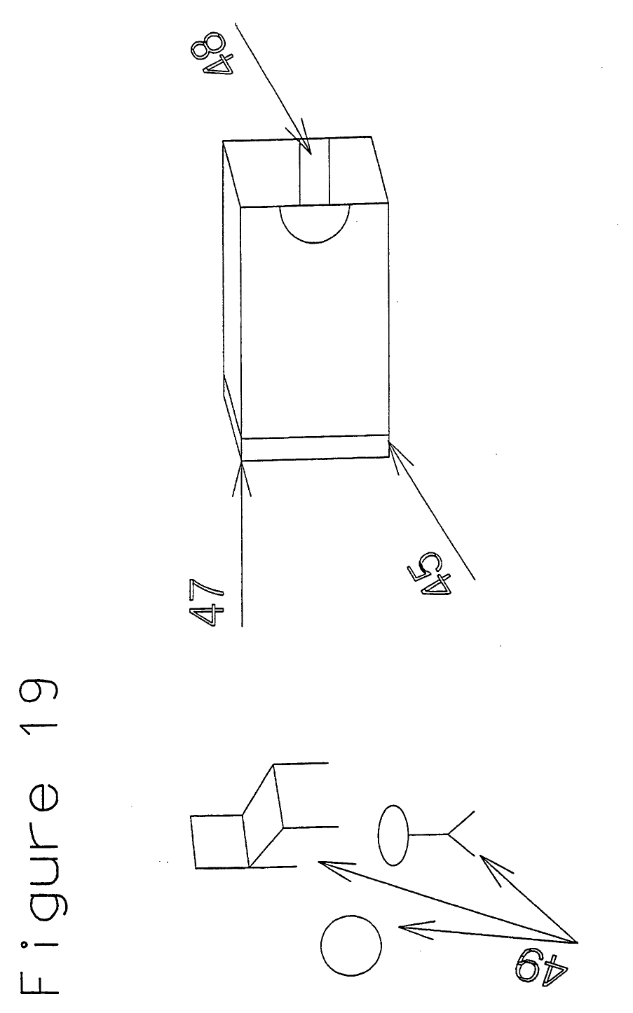

The screen 45 thus formed is then braced with a transparent sheet 46 on the front and the completed screen is preferably 1,024 cm by 768 cm in size. It is then placed on the front of a box 46 as shown in FIG. 19 1,024 cm by 100 long into which light cannot penetrate except through the screen on the front face 47 and a light source in the back 48. Each hole or tube 42 is given a unique number name consecutively in rows from the upper left corner to the right then starting the next row at the left again and so on until the last tube 42.

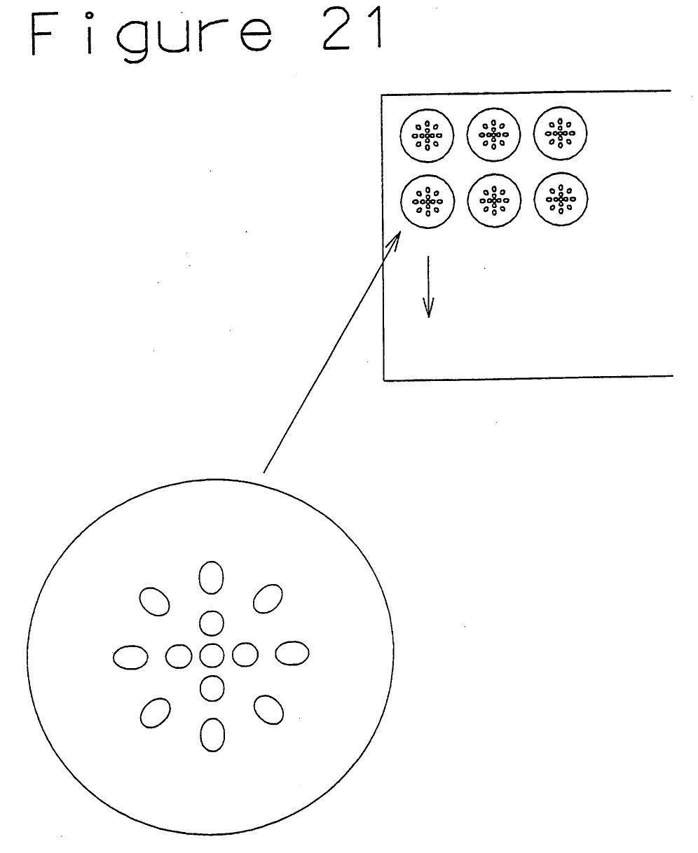

While the room is in darkness a transparent film is placed flat against the back of the screen in the box shown in FIG. 6. Some 3D objects are placed in the front of the screen about 3 metres away. The lights are then turned on and the film 44 is exposed through the screen for a sufficient time for light to travel down the tubes 42 without over or under exposing the film to much. The lights are then extinguished and the film is removed and developed into a transparent film with exactly the same size and dimensions as shown in FIG. 21. The film is then placed back into the box 46 reversed left to right as the image itself is reversed then the light in the back of the box is adjusted to a suitable brightness to see an image coming through the tubes 42 in the front of the screen 47. This image will be a 3D picture of the objects 49 placed in front of the screen earlier.

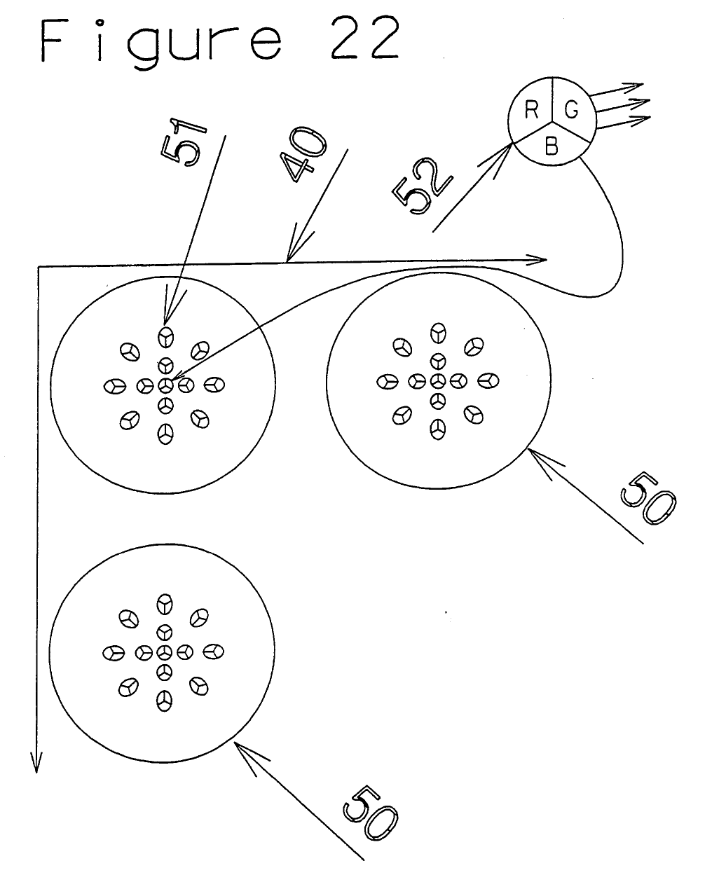

The film 44 is then imaged by a video camera so the exact film in FIG. 21 recorded earlier takes up a full frame in the recording medium such as a video tape. Alternatively the film is replaced with a panel of charged coupled diodes such as used in video cameras so that the bottom of each tube 42 has three ccd's, one for red, one for green and one for blue. This is shown in FIG. 22 which shows three part spheres 50 each having icons 51 with ccd's 52 for red (R), green (G) and blue (B) respectively.

The charged coupled diodes record the same image as the film digitally and are connected so as to give the same image on a video tape as photographing a film did. In this case the charge coupled diodes would have the same number designations but with an extra red, green or blue according to their colour. For example a tube might be 2,103 green as the 2,103 third tube with the green receptor. Essentially this is the same as moving the charged coupled diodes from in the video camera and connecting them by wires to the back of the screen using the same circuitry of the video camera to record the image shown in FIG. 22.

It should be possible to end up in both cases with the same image, except that the charged coupled diodes could record multiple images more easily so we could record a moving 3D picture say at 20 frames per second. In both cases one should end up with an image that would play back on a standard monitor looking exactly like the film recorded initially as a series of circles with coloured dots in them, not a 3D picture at this stage.

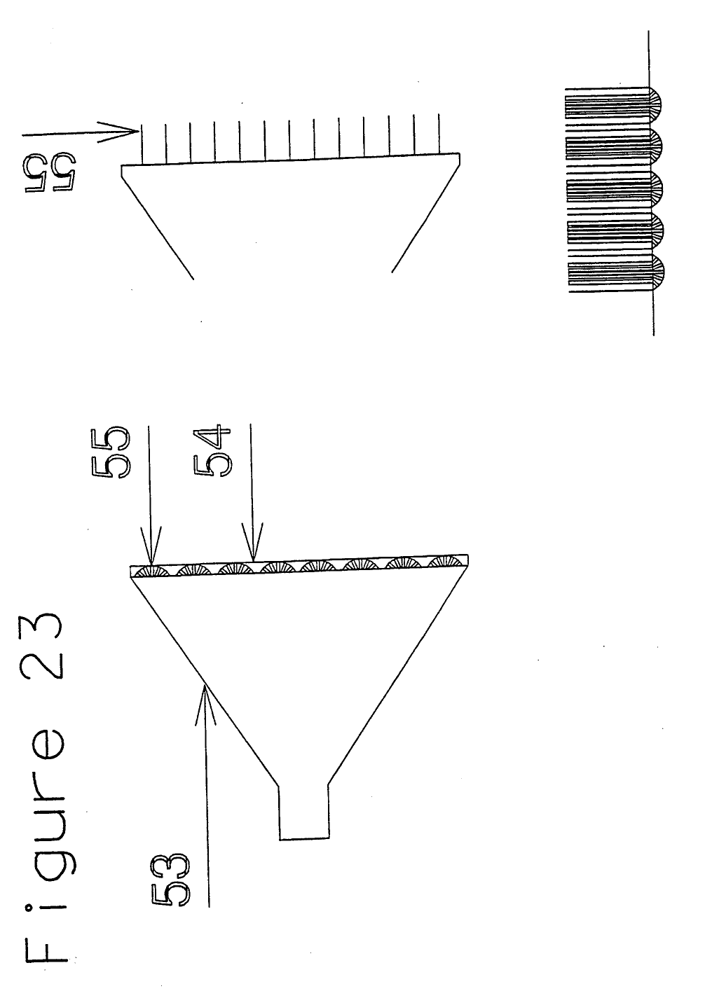

Next a monitor is to be manufactured to replay the image in 3D. A coloured cathode ray tube 53 as shown in FIG. 23 is designed with 1,024 by 768 part spheres (icons) pointing to the front of the tube with the same ratio of sizes and orientations as each of the semi-spheres in the recording device, but probably smaller as shown in FIG. 9. Also each tube has a number designation as earlier so that a tube in the same position on the camera and playback has the same number.

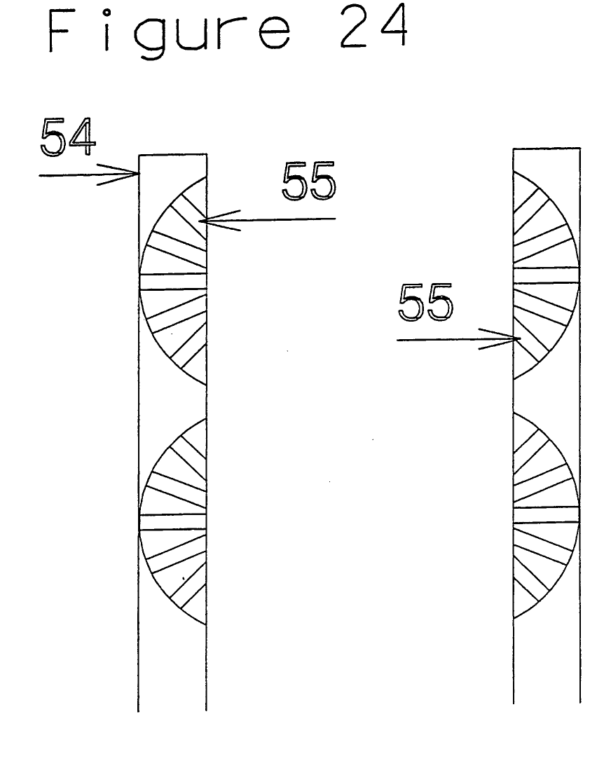

The signal is to be focused so that each tube receives the same light and colour intensity on playback as the corresponding tube did in the earlier box device. The video film of the 3D picture is played through the monitor so that each corresponding tube in the screen receives on the three coloured phosphor dots the same signal it would have received from the film in the box example before. That is each tube 55 of the screen 54 receives a particular light intensity from the film so now each tube 55 in the same relative position must receive the correct signal to make it emit light at the same intensity shown in FIG. 24.

In another embodiment a screen can be mounted outside a cathode ray tube with each pixel on the monitor screen connected by fibre optic cable 55 to the bottom of each cathode ray tube or tubes 55 (splitting the signal amongst several cathode ray tubes could also work) on the screen of icons. It is then a matter of ensuring the correct signal is beamed to each pixel on the screen to go to the right tube by ensuring the number designations of each tube 54 match up. A side line of this is that thin wall hanging screens can be made both of the 3D type discussed previously and a standard 2D picture by sending the picture up the fibre optic cables 55. The fibre optic cables 55 can each connect to a liquid crystal screen or screens (if the signal is again split up onto several liquid crystal screens to transmit the signal to the large single wall hanging screen) separate from the wall hanging screen and transfer the signal.

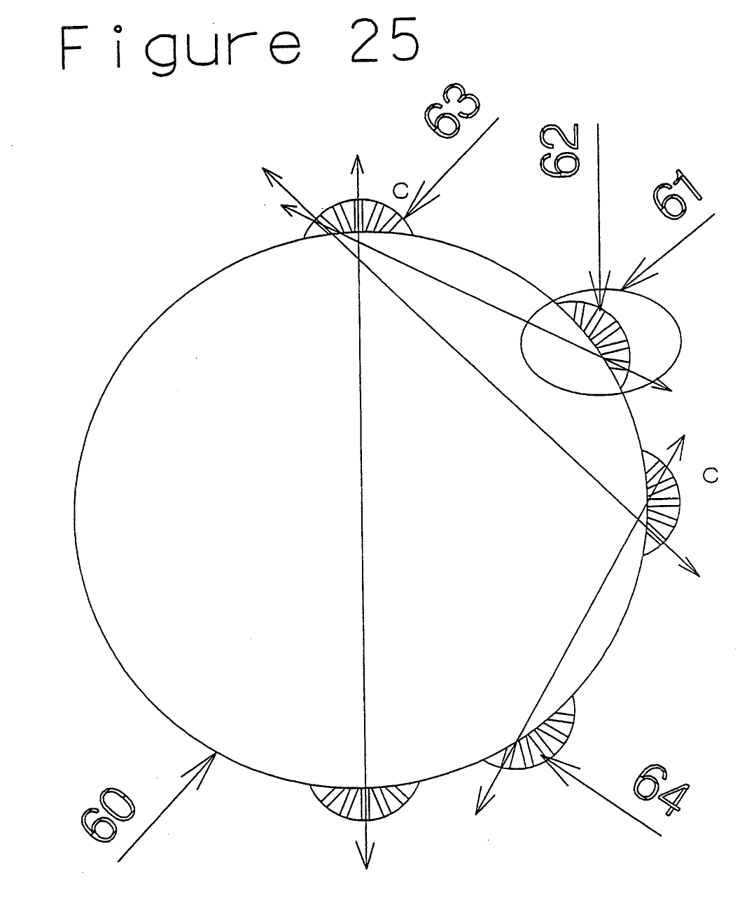

According to another embodiment of the invention a cloaking device can be simulated using a sphere 60 as shown in FIG. 25. The sphere used as an example is 1 metre in diameter. All over the sphere part spheres or icons 61 are attached, these being the same as used in the aforementioned recording device. The positions of these icons must be such that each tube 62 of the icons must have a line of sight straight through the sphere 60 to another tube 62 in another icon 61. If one places as many icons as possible within these guidelines each tube 62 also has a unique number designation.

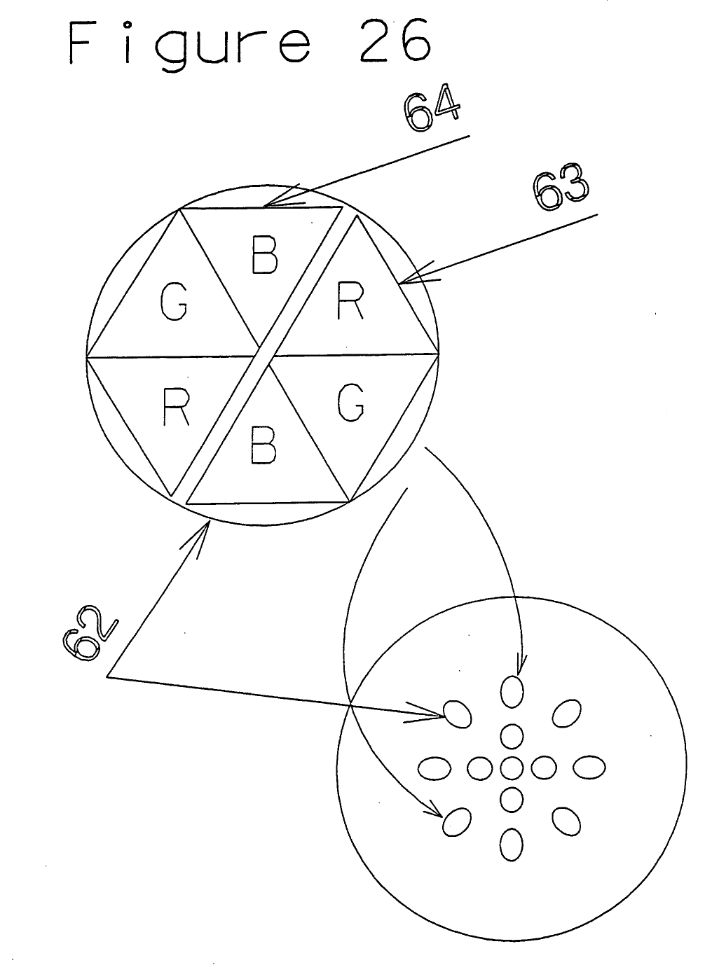

Inside each tube 62 there is a divider with one side containing a receptor and one an emitter in this case of light. The receptor 63 can be a charged coupled diode one receiving one red, one green and one blue as shown in FIG. 26. The emitter 64 can be three light emitting diodes, one emitting red, one green and one blue also as shown in FIG. 26.

Each tube is to be linked to its corresponding line of sight tube 62 so that the receptors send their signal to the corresponding emitter of a colour and intensity the same as if the emitting tube had a clear view of the object beyond.

These intensities may be varied for other effects. Essentially the electronic circuitry in the large sphere acts as if all the receptors were like one spherical charge coupled diodes screen in a video camera and the emitters act as one spherical display. If the receptors and emitters are linked as shown then the device need only record the image and replay like a normal camera and monitor as the shapes of these images are relevant to the circuitry employed.

The effect will be that the large sphere 60 will appear somewhat transparent and to the degree the part spheres and tubes are further miniaturised then it will appear more so. Thus in an ideal situation the icons are infinitely small so that it is impossible to tell whether the image is real or not.

If the sphere is sent rolling it should retain its transparent aspects as it moves around.

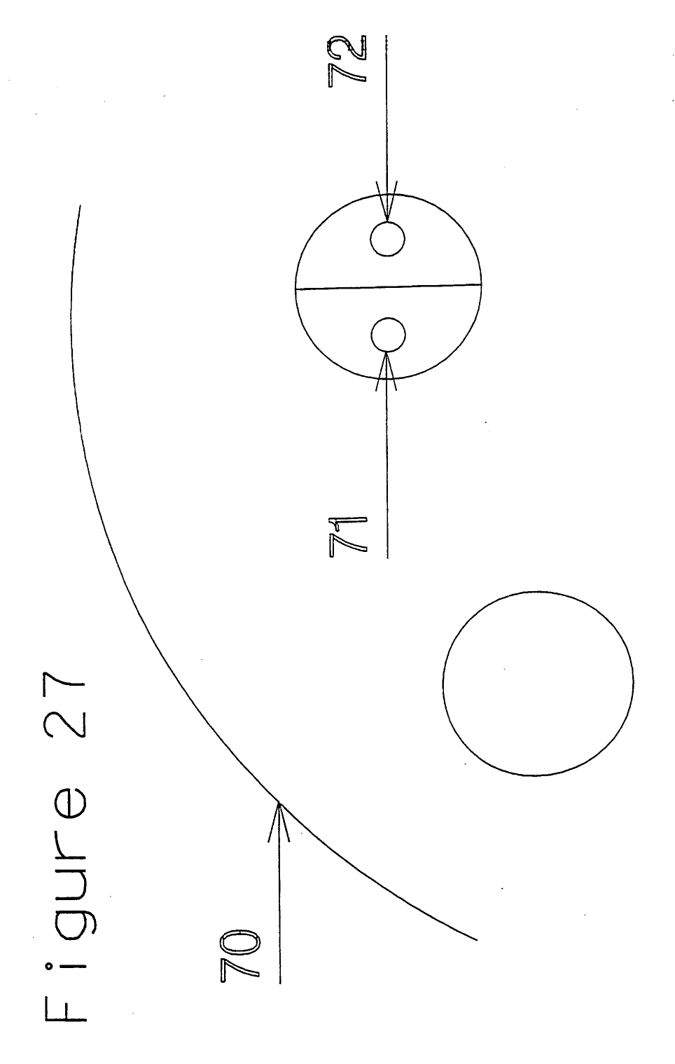

The receptors and emitters can be dealing with any type of signal, not just electromagnetic radiation as previously discussed in relation to other embodiments, for example sound or radar. In the case of sound each receptor acts like a microphone, each emitter like a speaker and the inner circuitry relays the signal as before as shown in FIG. 27 and represented by sphere 70, microphone 71 and speaker 72. There would be some built-in filter to remove sound microphones 71 picked up from adjacent speaker 72. In this case the sphere would appear somewhat acoustically transparent and under water would be harder to detect with sonar. Also the time sound would take to traverse that line of sight in the sphere would be set to a corresponding delay between each linked emitter and receptor.

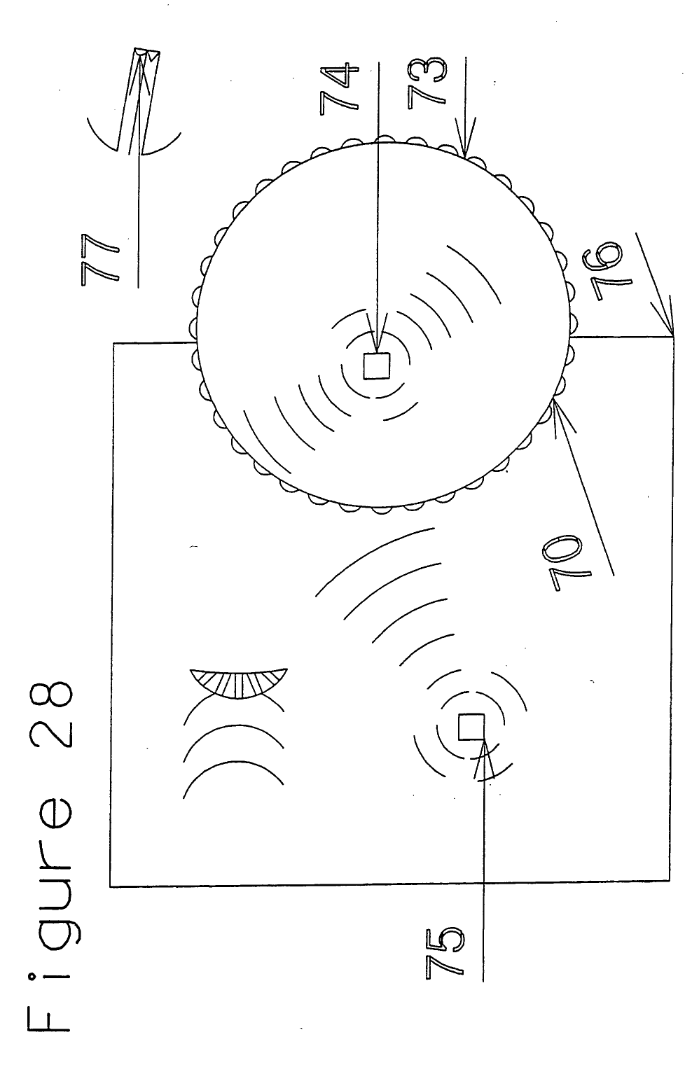

This can also act as a dampening device as shown in FIG. 28 where a sphere 73 is affixed in a wall with a noisy motor 74 inside it and another motor 75 on one side of the wall 76. In this case each emitter 77 being a specific form of icon would play a sound out of phase to the sound received in the microphone next to it. This would have an effect of cancelling both each sound as it passes into the sphere and each sound remaining as it exits the sphere so that the noise from the motors would be reduced.

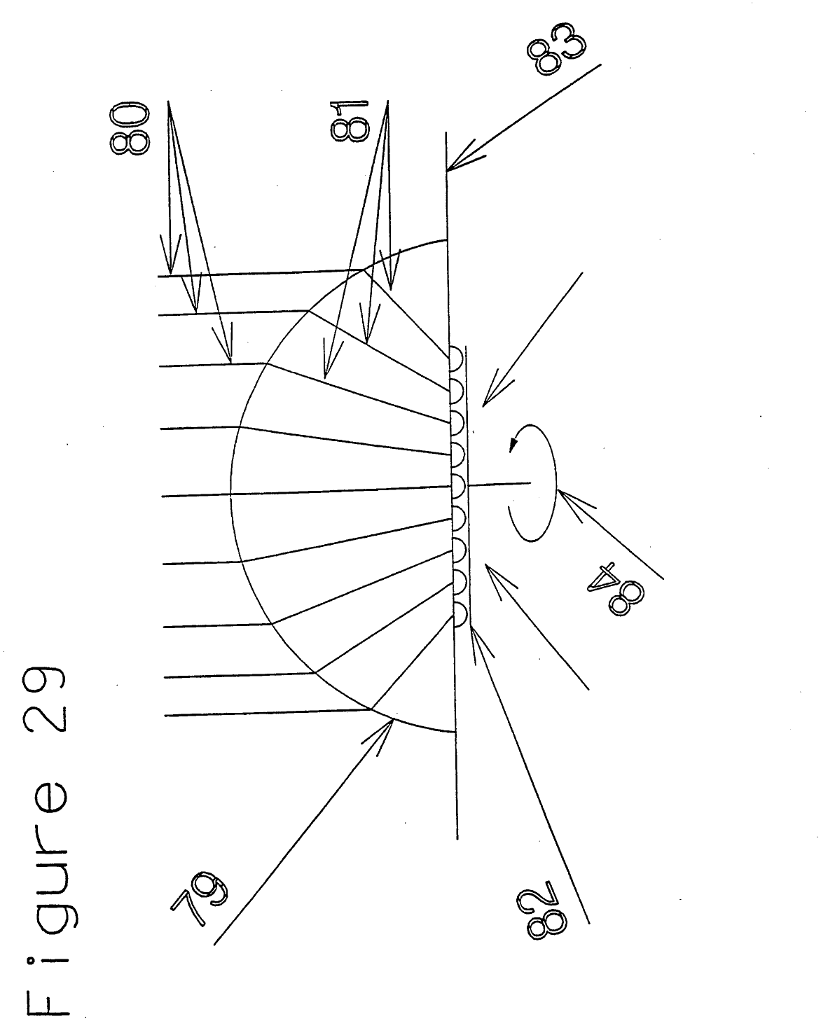

According to other embodiments of the invention screens incorporating the inventive concept can be adapted for electronic circuitry as shown in FIG. 29, both for manipulation of data in a cloaking device and recorders, but also in computing. For example a screen is manufactured as before but with a wire 80 being placed down each tube 81 to a record playback head 82 at the base 83 of each tube 81 similar to a head in a hard drive as shown in FIG. 29 where there is a spinning recording medium like a platter in a hard drive with the centre of the drive in the centre of the screen.

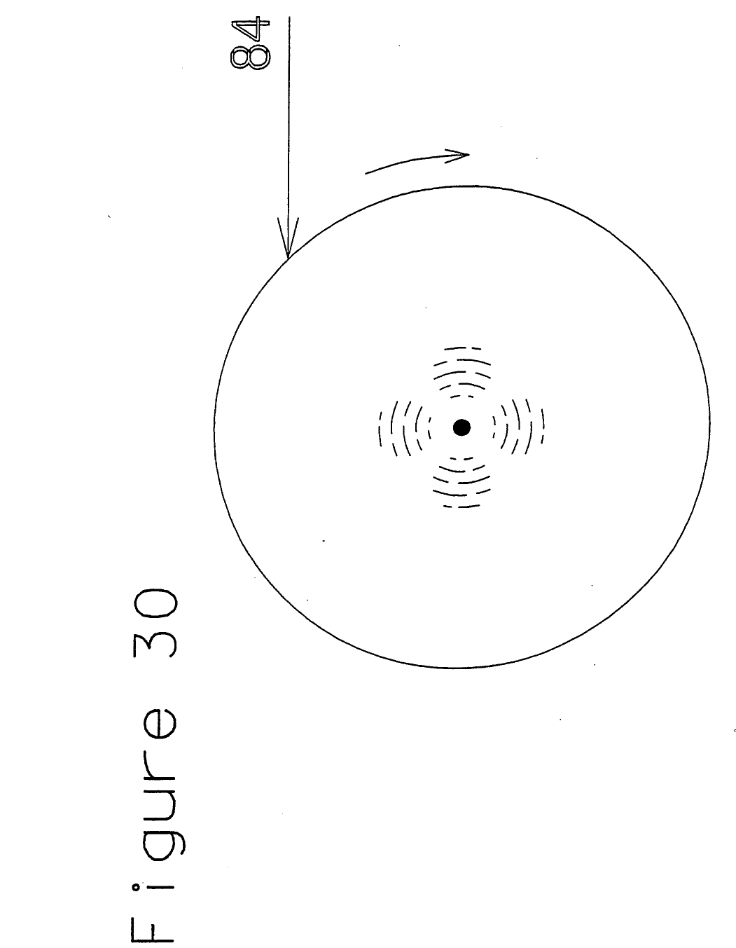

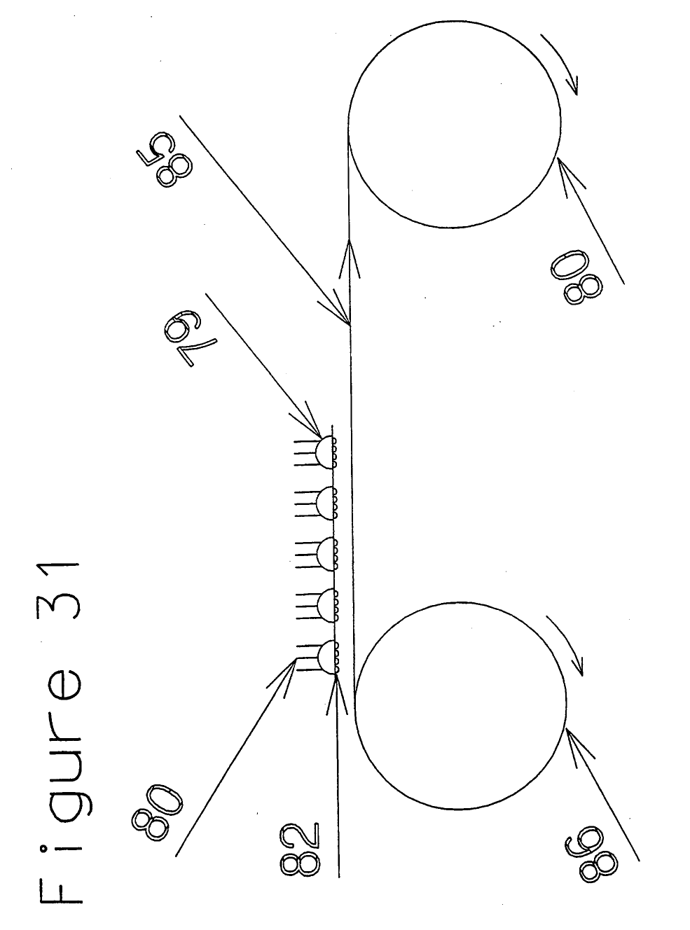

The wires 80 are hooked up to input devices such as for example the recording screen and its charged coupled diodes. A signal will pass up each wire and record with its head the same relative intensity as the light signal received down each tube 81 of the recording device 84 shown more clearly in FIG. 30. The platter spins rapidly so that each signal recorded is a short arc that does not overwrite the recordings of adjacent tubes 81. To play back this signal the platter is spun and at the correct moment the heads read the recorded arcs, send those signals up the wires and the image is replayed. Instead of a spinning platter a tape 85 movable on spools 86 can be used for multiple images as shown in FIG. 31.

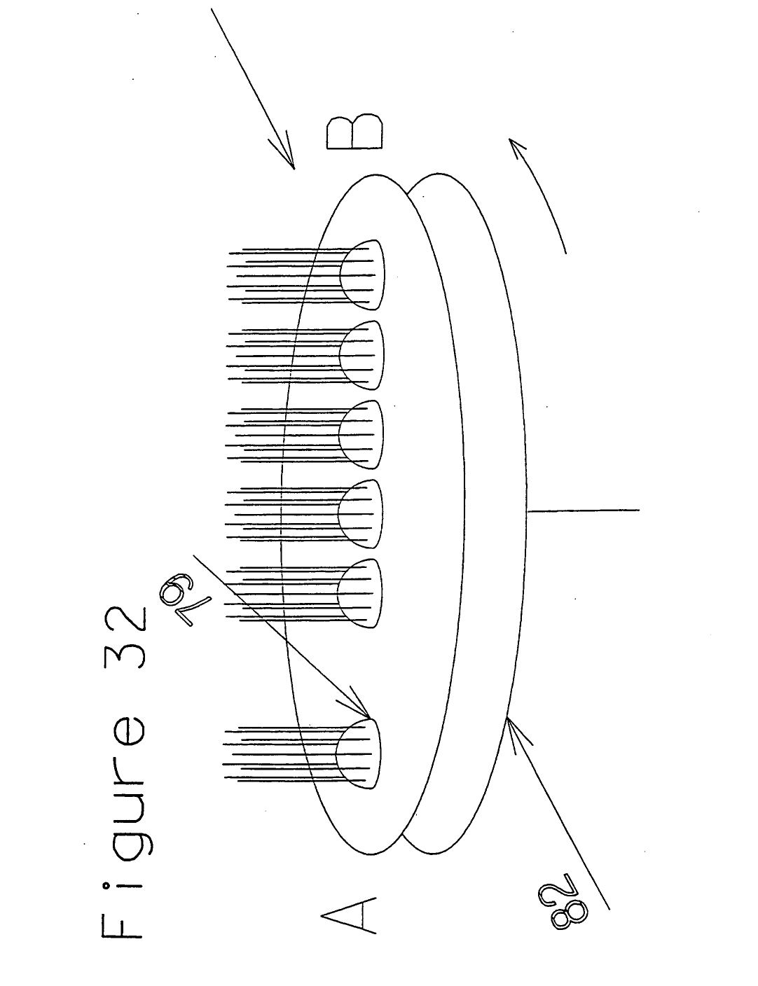

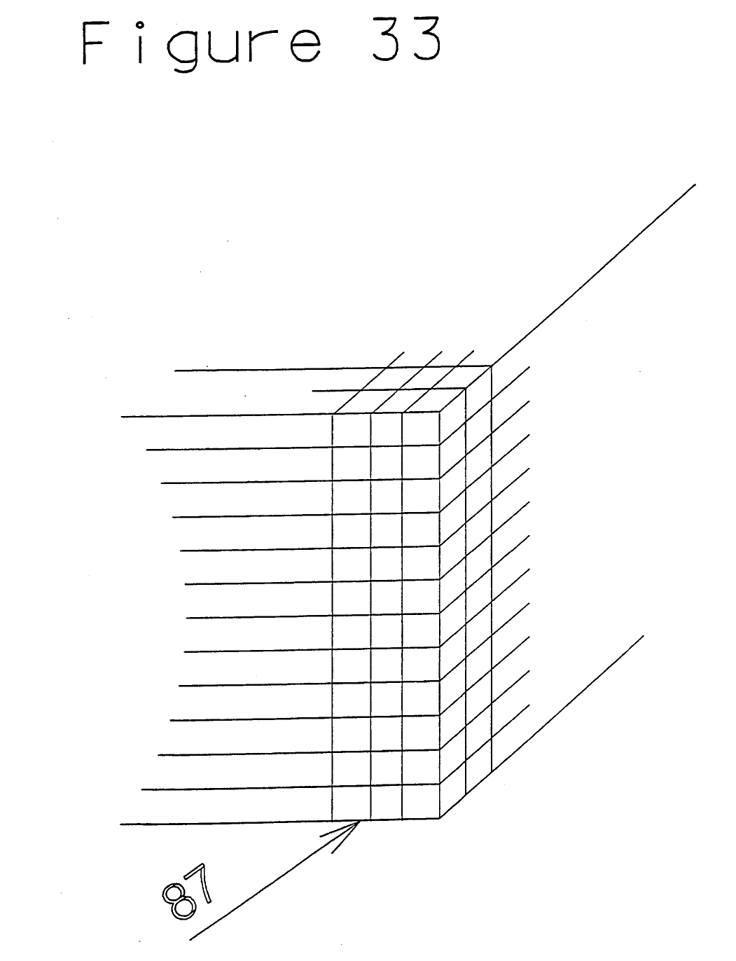

The same principal applied above can also work as a kind of random access memory when signals like 0's and 1's are sent down the wires and recorded to the spinning platter. On playback the device looks for the addresses of the 0's and 1's and waits until the next available heads in some orientation pass over those points and then reads back the data correcting it to the upright orientation as shown in FIG. 32 in the case of the spinning platter 82. This recorded digital information can be of any type but it can also be a 3D lattice of 0's and 1's that a computer views by looking at an address in that lattice through two wires like the two eye viewpoints of an observer looking at a screen as discussed in the first embodiments shown in FIGS. 1 to 4. This embodiment is shown in FIG. 33 where an example of a lattice 87 is shown in a 3D storage medium. Thus as shown in FIG. 33 a computer views a memory address of the lattice 87 as a person would a 3D point.

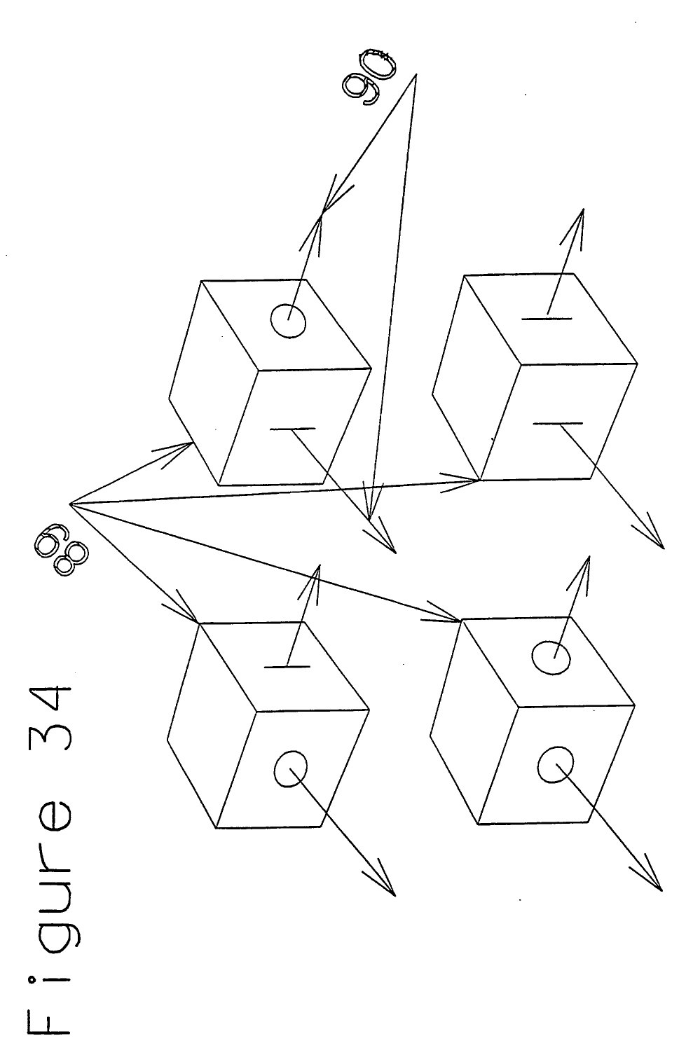

Each point in the lattice 87 can be viewed as multi-faceted so that each “eye” or “viewpoint” the computer uses may see different information. For example looking at a memory address in 3D one view point may see a 0 and the other a 1. The other combinations are 0;0, 1;0 and 1;1, thus four possible states are recorded by the two viewpoints on the one point on the lattice 87. Looking simultaneously through more than two viewpoints means more different facets of a memory address are seen and thus more information is stored as shown in FIG. 34 where four states observable at a single address 89 are shown with wires 90 connected to each of the faces of the address.

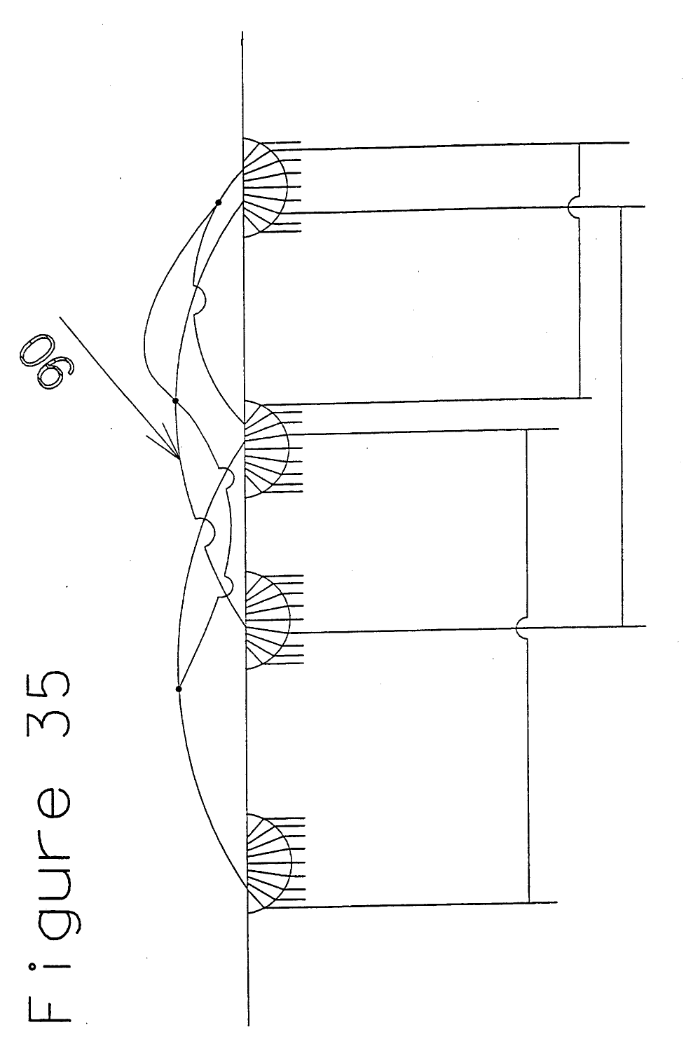

Instead of memory addresses the bases of the wires 90 can be connected with other wires shown in FIG. 35. In this way points in the lattice can be connected to other points by all kinds of logic circuits so a viewer can input data at one point in the lattice and another viewer sees the output elsewhere. In effect all possible connections can be viewed in 3D or higher dimensions.

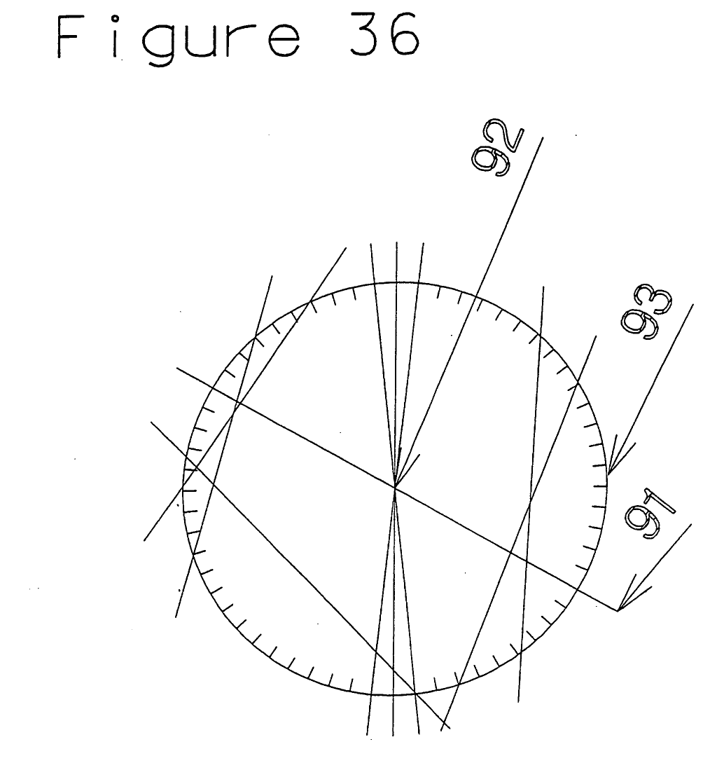

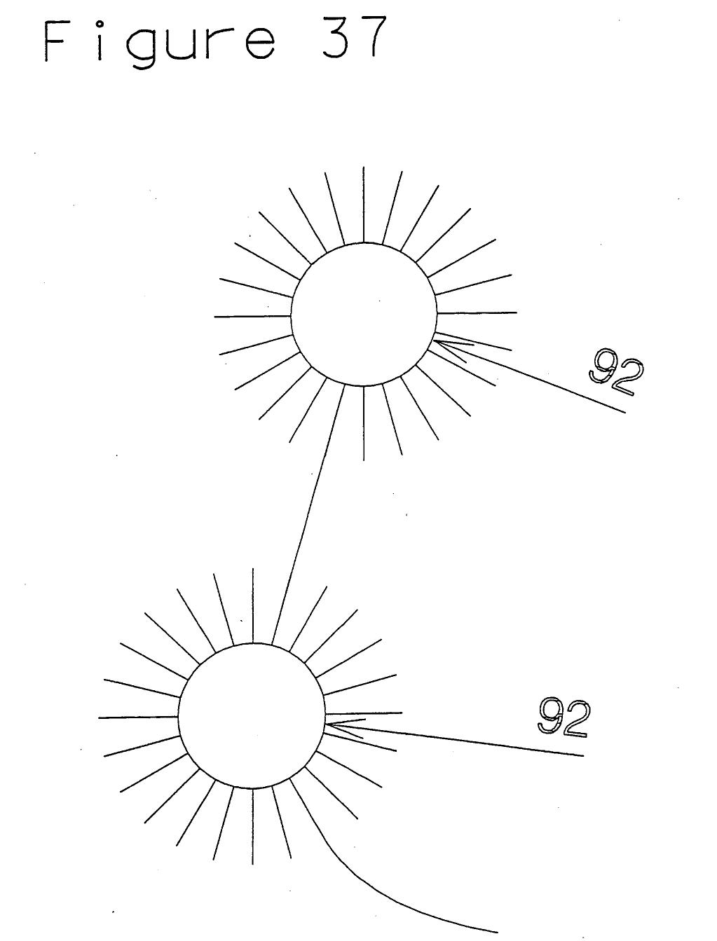

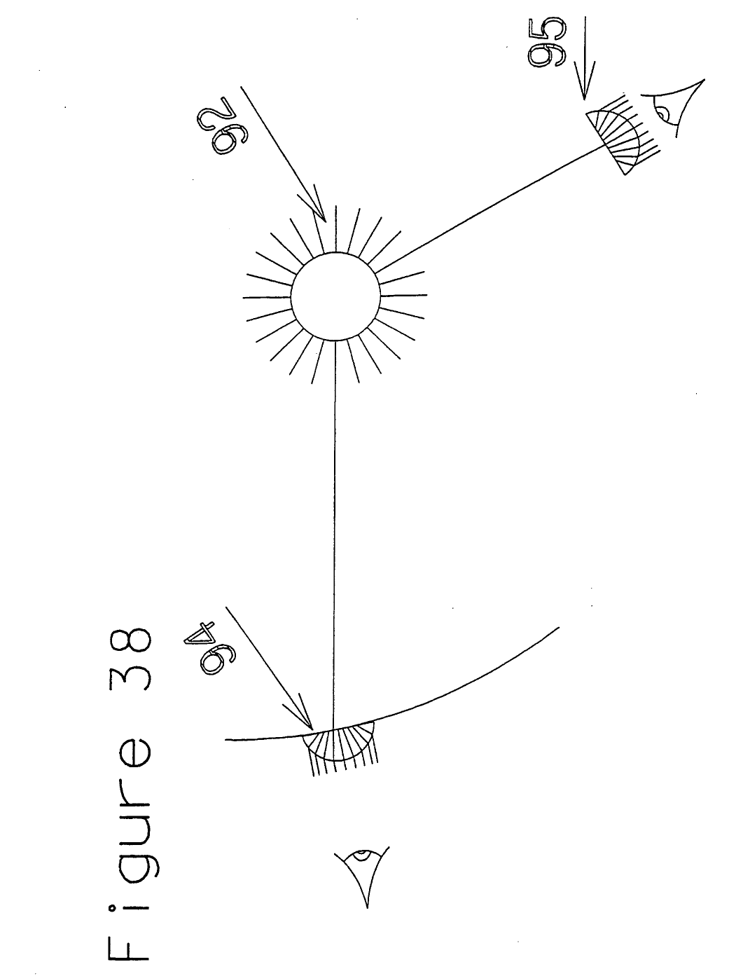

In an electronic adaptation of a cloaking device embodiment of the invention discussed previously a sphere is again covered with icons with wires down each tube but each wire connects to another tube in the line of sight, though other connections are sometimes used. The points where wires would intercept as shown by lines 91 in FIG. 36 can for convenience be called nodes 92 which are shown in more detail in FIG. 37. The nodes 92 are multi-faceted points in this lattice where each input wire connects to a facet. Inside these nodes can be any kind of circuit including logic circuit, 3D imaging and playback as shown before and 3D wiring. Each node 92 can be addressed by other devices connected to the wires on the outside of the sphere 93. The sphere 93 can be interacted with bi-viewers which are pairs (of three or more) of “eyes” that can “look” at any facet and send to or receive information from it as shown in FIG. 38, where a viewer 94 and a viewer 95 both see node 92 but may not necessarily look at the same pair of facets on node 92 as the other viewer so that each can operate independently of the others and anything blocked from sight of a viewer can be compensated in the wiring in the nodes 92.

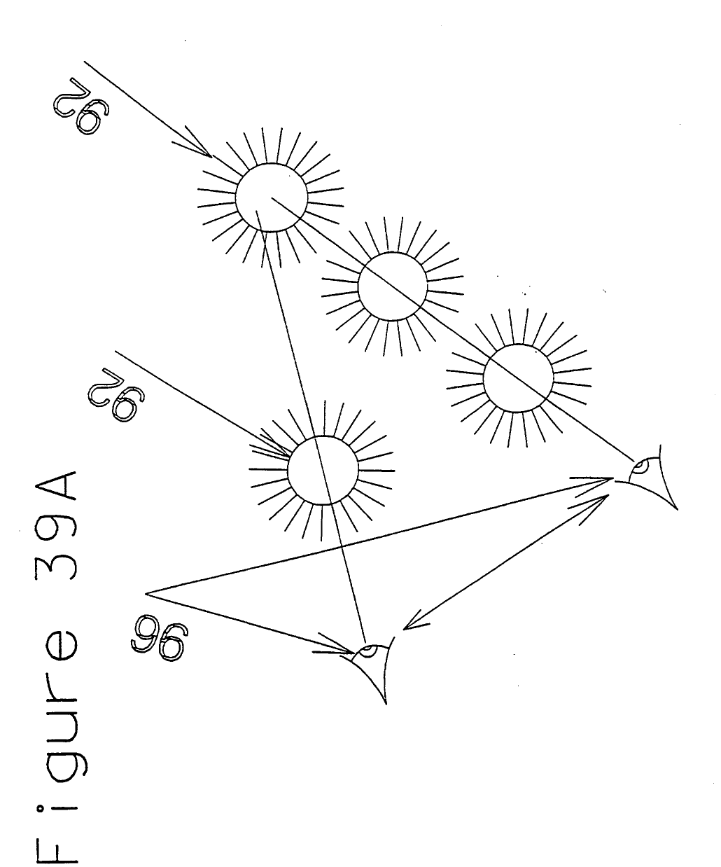

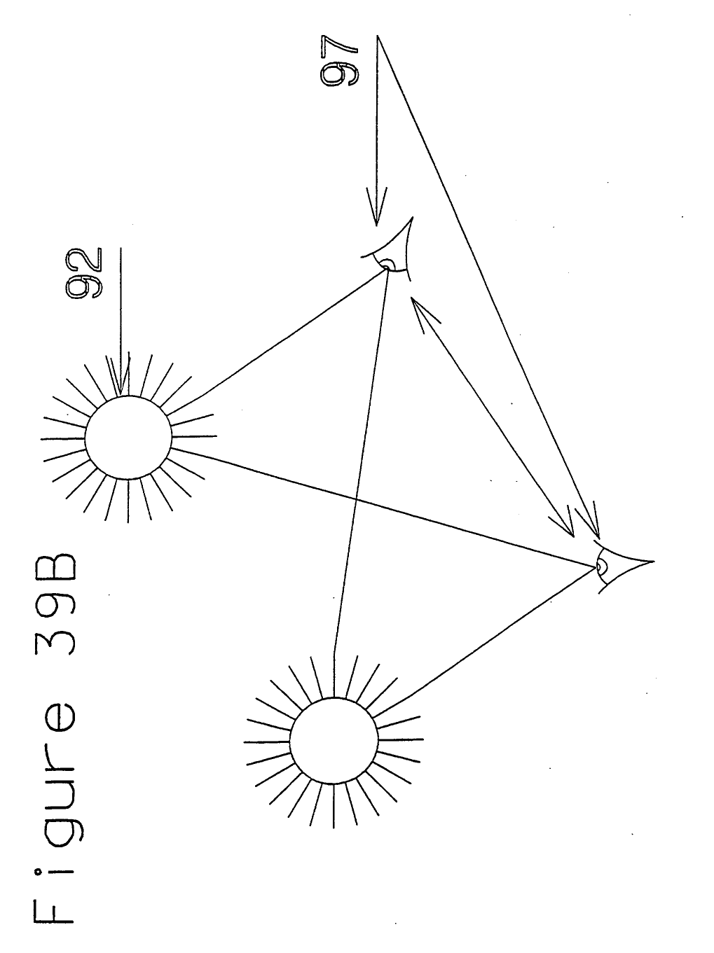

Because the nodes are multi-faceted many viewers can interact with the same node by looking at different pairs or more facets of that node. The total system can interact with the sphere 93 by designating viewers to perform different tasks. Viewer one 96 might activate the nodes it views and inactivated nodes might be transparent to circuits that pass through them as shown in FIG. 39A, which shows a number of nodes 92.

Viewer two 97 might cause consecutive nodes it views to have an open connection between them as shown in FIG. 29B. A third viewer might cause the node it views to open various facets and close off other ones. A fourth viewer might cause the nodes it views to activate Booleann logic circuits in those nodes. A fifth viewer might erase some of those operations. When a computer wants a task performed it is able to split it up into viewers to construct their specialised parts.

Essentially then the viewers can create custom circuits in the sphere to perform tasks in three or higher dimensions then alter or erase them to perform other tasks. The device is regulated by a computer clock to synchronise these operations and information stored in a three or more dimensional lattice described earlier like RAM in a modern computer. Information as numbers and connections can be stored in a multi-dimensional lattice so the device can improve on its connections and create an optimised circuit as needed. All the different possibilities group theory would allow can be created in this system. Instead of a chip being predesigned it could be designed, used and changed in real time.

Higher dimensional logic circuits can also be created and altered by viewers with three (or more) eyes. The circuits could for example be a four dimensional series of logic circuits which are set up so that they work first in sets of three dimensions with two of three eyes, say eye one and eye two. Then they are viewed with eye two and eye three as a three dimensional circuit that has two dimensions in common with eye one and two, but a third dimension independent of them. Then they are viewed with eye one and three, which is three dimensional again but has two dimensions in common with each of the previous viewers, so each pair of eye interacts with a unique three dimensional circuit that functions in four dimensions. With more eyes the number of dimensions can also be increased in proportion.

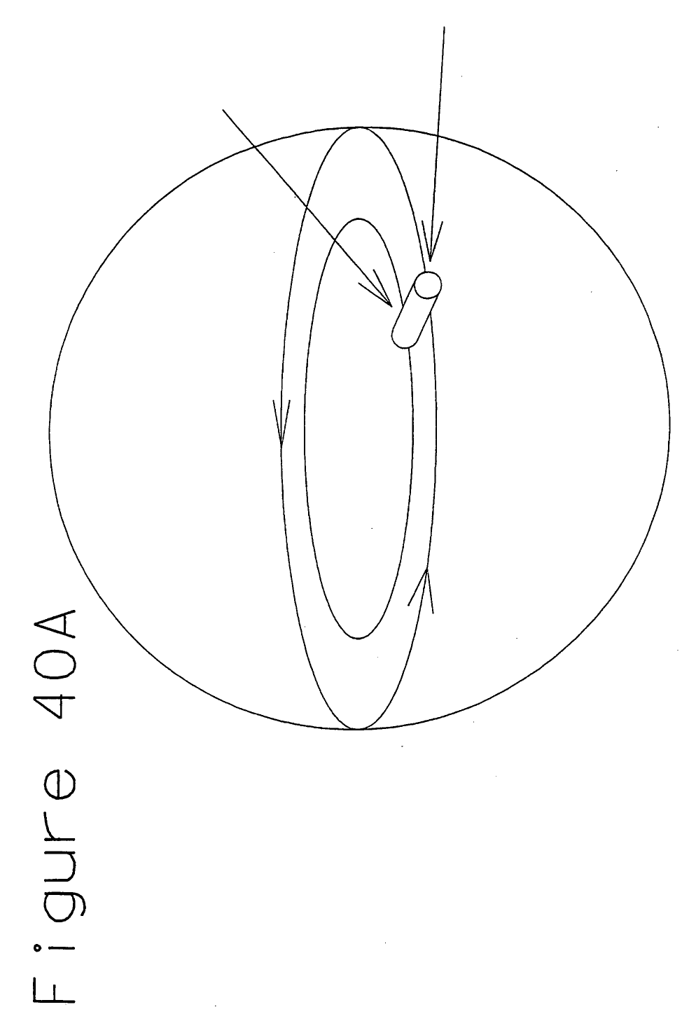

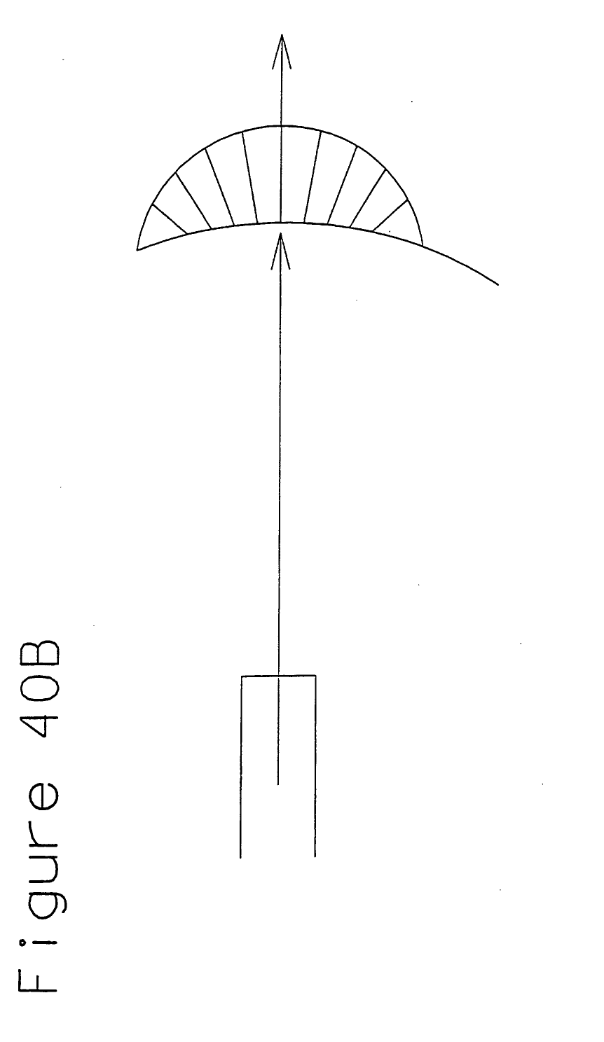

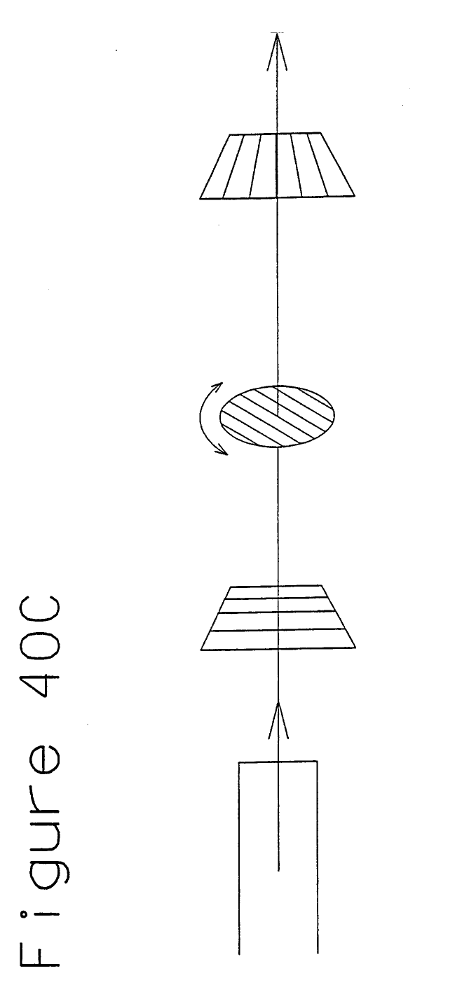

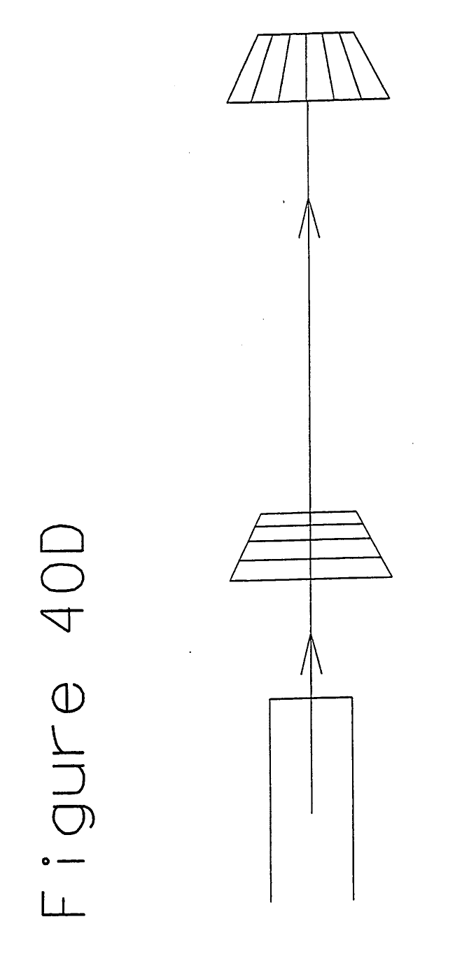

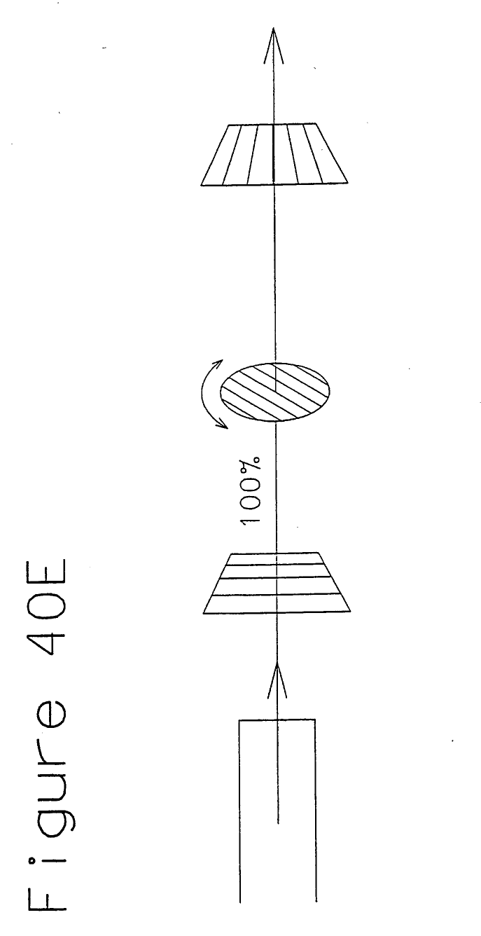

According to another embodiment an image may be shined on a screen using a sphere which is designed in a similar fashion to the previously described cloaking device with icons densely packed on its surface with the same dimensions and with each tube having the same number designations. Inside the sphere is a ring with a laser in it that rotates 360° at constant speed and is motor driven as shown in FIG. 40A. The laser is fine enough to shine exactly on dots at the bottom of each tube in the part spheres (icons). When the laser shines on these dots they either glow or simply pass the laser light into the tubes shown in FIG. 40B. They may have a red, green and blue dot to glow in colour.

In front of the laser beam is a set of three polarised transparent glasses as shown in FIG. 40C. If the central glass is removed then light cannot pass through the remaining two glasses as they are polarised in directions perpendicular to each other shown in FIG. 24C. If the third glass is replaced and set so that it is polarised at 45° to each of the other two glasses then light can pass through the three glasses. If the middle glass is rotated then the light passing through the three glasses will vary from 0 to full strength as shown in FIG. 40E. Alternatively more than one glass can be rotated to give the same effect. In place of the glass liquid crystal can be used, because when activated their polarity rotates as well.

As the laser shines through the glasses the middle glass is positioned so that light shining on the base of the tube aimed at is correct to make the tube emit light the same as the receptor tube with the same number. This is the same as when the original box shone light back through each tube with the same number to give a correct picture as well as in the cathode ray tube embodiment. If the ring is rotated then a ring of tubes on the outside of the sphere will glow with intensity according to the positioning of the middle mirror. Alternatively the laser can remain stationery and rotating mirrors can move the light beam around the sphere. The ring is then mounted on an axial that protrudes from the sides of the sphere shown in FIG. 24E so the ring can rotate stably inside the sphere. This axial is rotated at a constant velocity.

The laser as it rotates can bath the bottom of each tube on the sphere and if it spins rapidly enough any flickering would be un-noticeable. By an outside signal such as radio waves the laser mechanism inside can rotate the central glass so that by manipulating this signal the light intensity can be irradiated through each tube at almost any time.

The picture from the cloaking device's receptors is relayed into the second sphere as follows. Where each receptor before sent its signal to an emitter in the line of sight it now sends its signal to the tube with the same number designation in the second sphere. Picking a single tube as an example. When the laser is due to pass over the tube with the same number in the second sphere the mirror is adjusted so light with the same colour and intensity comes out of that tube as went into the original tube receptor. This same process is then done with each tube. This causes the second sphere to give an image all over its surface like the cloaking sphere. One can send any signals to any tubes as desired. Fibre optic cables can then be attached to the exterior of each tube and the signals can be sent to a wall hanging flat screen where the fibre optical cable is attached to pixels as desired. The sphere can receive a signal meant to be viewed on a shape other than a sphere and transfer it to the correct screen in this manner.

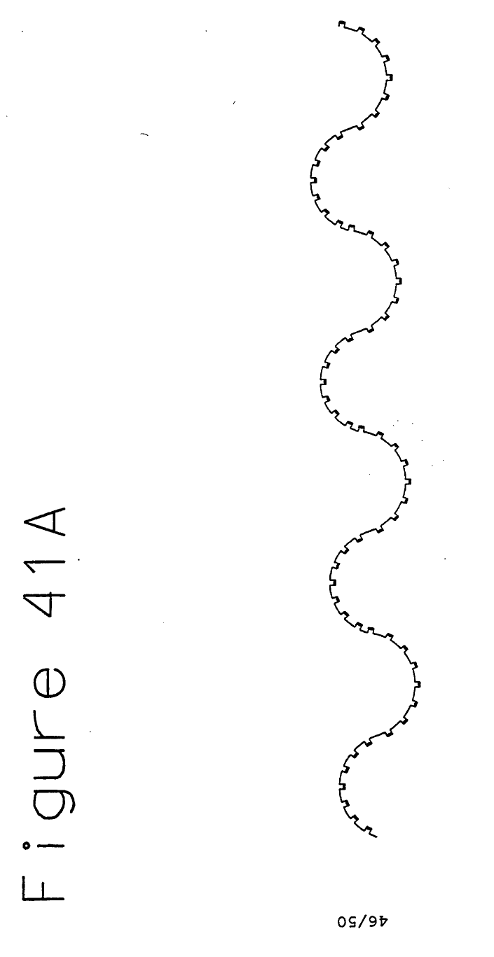

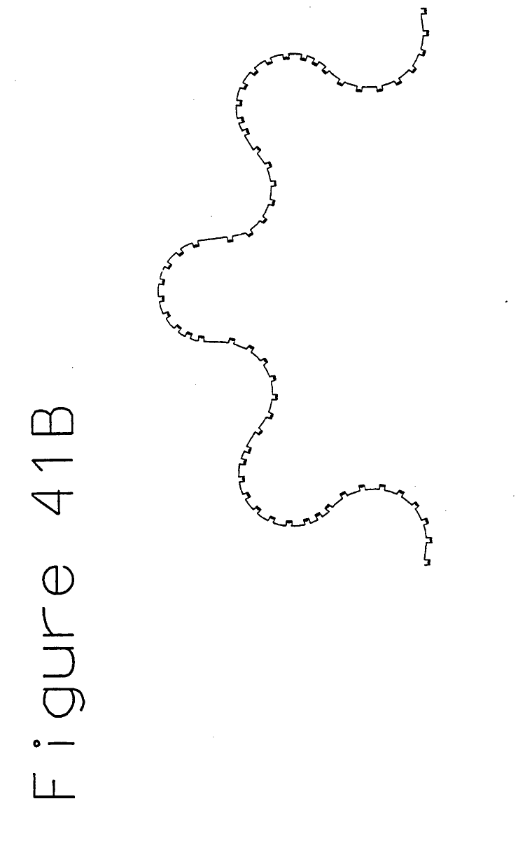

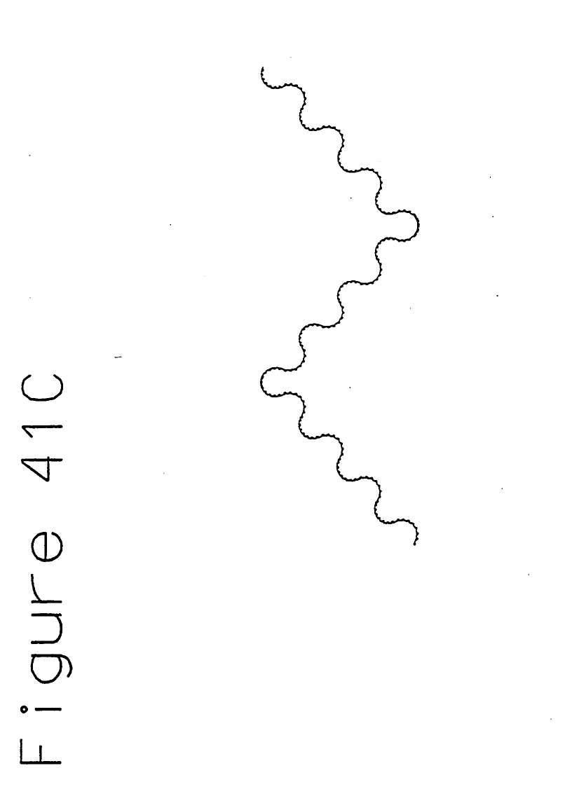

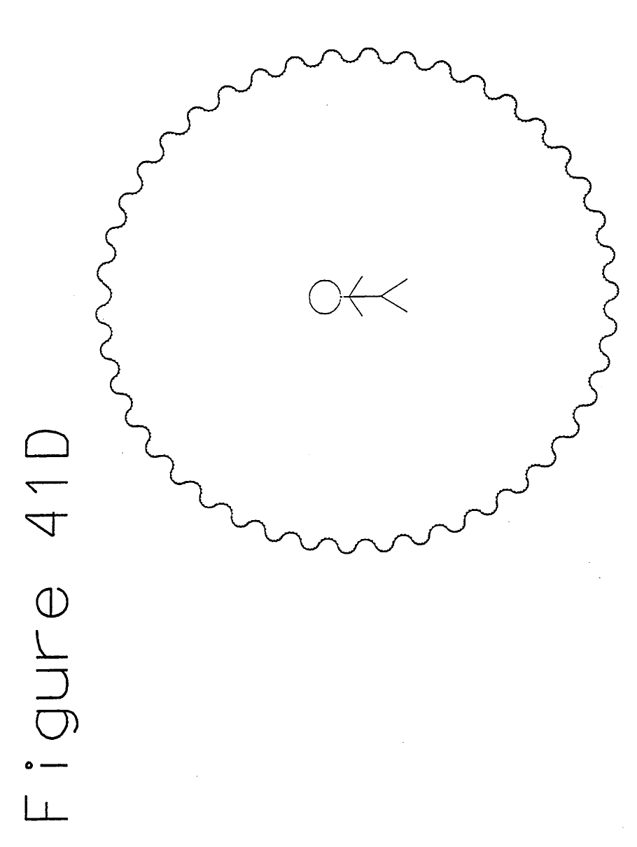

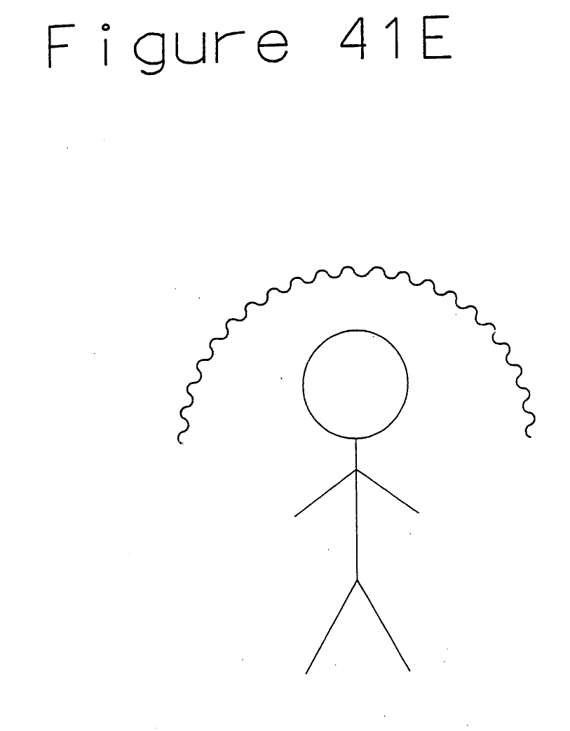

From the embodiments which have been described previously it should now be clear that there are many variations and applications for the concept of converting a two dimensional signal to a three or more dimensional image signal. FIGS. 41A to 41E each show different configurations of a screen having a wave like configuration but which is formed into a particular shape, thus in FIG. 41A the screen shown is generally straight, in 41B the screen is formed into a curve. In FIG. 41C the screen has a sinusoidal waveform appearance. In 41D the screen is a fully enclosed device. In FIG. 41E the screen is arranged as a curved helmet.

Thus from the above it can be seen that various screen shapes are possible. Flat screens can be used or spherical or any other shaped screen. A viewer might see pictures from a spherical recording device so that whenever that person looks and moves in the sphere that person sees a three dimensional image. The person may also view artificially generated pictures such as those in games or software programs like Windows or Office in this way. Furthermore, the screen may form lenses of a pair of spectacles.

It is also possible that 3D images can be printed on various surfaces. Thus paper may be imprinted by a printing head in the various shapes to give a 3D image. The paper or any other medium can be printed in another shape such as flat then moulded or transformed to the applicable viewing shape. Material such as concrete or plastic can be moulded with a picture. Icons can be inserted into or be placed on the media which may be polarised, etched or contain tubes or reflectors to give the 3D image.

Objects can be partially or wholly covered with screens for various effects. Thus a fabric may have 3D pictures superimposed on it. Thus a window may have the glass impregnated with partially transparent 3D images that can act as filters stopping light from certain directions.

According to other embodiments of the present invention pictures can be built up icon by icon and therefore pixel by pixel as follows. If we assume there is a globe of the world in a box with a screen on the front because the screen is a 3D imaging one we can see the globe from any angle through the tubes of the icons in 3D. What is needed is to calculate the light that must be emitted by each pixel to make the globe appear accurately in 3D. The globe is covered with dots (F)1, F(2), F(3), . . . each point as F(X) where X is a positive integer. A line drawn from F(1) onto the screen will strike it at an angle I which we will call E(1, Y, Z) and the point I we will call G(1, Y, Z). Drawing a certain number of lines onto a screen represented by A B C D will generate a number of points numbered consecutively so that Y, Z are also integers from 1 to say 1,000. This means that for example E(21, 31) would be an angle where the 21 is on the line A,B and the 31 is on the line C, D. The purpose of this is to define each of the 1 million points on the screen A, B, C, D with the correct angle to any point (F)X on the globe. Each angle E and point G must then be mapped onto the correct part of the screen. Each tube of an icon in this case has a certain angle broken into horizontal and vertical co-ordinates. A point G is then defined with horizontal and vertical co-ordinates and with horizontal and vertical angles. These angles define which tube that line of sight F(X) should go on. If that line of sight does not fit directly into a tube then that light must be divided amongst the tubes directly closest to that line of sight in the intensity so that the effect is closest to their being a tube directly in that line of sight. By mapping each point F(X) in this way the globe or any object can be calculated to be mapped on any screen. If there is a light source shining on the globe then the reflected or refracted light reaching the screen is mapped in intensity according to the angle between the light, (F)X, and the point on the screen being calculated. A point on the globe that is obscured by another point is also calculated to not appear in the image or to be dimmer if the globe is translucent.

Using the above method it is possible to map objects onto screens and transform those mapped images for use in various software programs and pictures such as Windows, word processors, art programs, games, movies (combining graphics with photography) and so on. Cameras from different angles can provide different view points that can be synthesised into the between 3D images by mapping the 3D images between the cameras. Two cameras may be sufficient for mapping into a helmet or onto 3D glasses as the eyes cannot move to another viewpoint. Thus the screen stops each eye from seeing what the other can see.

Objects can also be mapped in more than three dimensions as previously discussed in Hilbert space. If you think of each point F(X) on the globe as somehow changing in several variables then you can map those variables to each point on A B C D. Heat, decay, time dilations, colour changes, etc. can be mapped to each point. Games and objects can be constructed in n dimensions and displayed on a screen. A Rubics cube or the sliding number puzzles designed by Sam Lloyd and other puzzle games such as jigsaw puzzles can be constructed to change consistently through other dimensions. By looking at three dimensions at a time the puzzle can be solved in n dimensions. For example imagine a Rubics Cube in which there were four symbols on each cube's face, with a total of 26 facets. Each facet would be represented by an image device such as an LCD screen. Twisting part of the cube might mix some of the colour facets but in this case it mixes one of the symbols on the faces though the colours are not mixed. Hitting a button means that twisting the cube then mixes the second symbol, then hitting the button makes twisting the cube mix the third and fourth symbols then finally the colours. The cube is now totally mixed although a solution must exist because applying these transformations in reverse order must restore the cube to the start.

The general concept of the invention which has been exemplified previously has many applications far beyond the basic example of a television which is able to emit images which can be seen by a person as a three dimensional image. Any recording medium which is capable of storing data, whether it is showing the underwater topography of a landscape, an internal organ of a creature, heat flow patterns in the atmosphere or the live action of a sporting event can now convert that data into images which are emitted or radiated by pixels of icons so that a person is able to see the same three dimensional image which was stored. Furthermore, the general concept can be taken further when the observer of the three dimensional image which is emitted by the pixels is replaced by a mechanical device or electrical device instead of a human being. Thus computers will be able to be designed to see three dimensional images themselves and thus recordal of data in three or more dimensions enables a greater amount of data to be stored and retrieved, whereas previously the retrieval of such data other than in a two dimensional form was not possible.

1. A signal making and/or receiving device:
(a) where including at least one emitter, receptor, feature, pixel, bump, tube, ball, or lens, the elements have a plurality of non uniform dimensions in width, height, shape, and distance between them on or in its surface,
(b) where including at least one emitter, receptor, feature, pixel, bump, tube, ball, storage device or lens, the elements can be arrayed in a periodic, irregular, non uniform pattern,
(c) where including any ratios of sizes and shapes of a plurality of elements characterized by emitters, receptors, features, pixels, bumps, tubes, balls, lenses, the elements compared to at least one other element can be adjusted and varied while maintaining a non uniform periodic array,
(d) where the elements, including at least one emitter, receptor, circuit, feature, bump, tube, dot, ball, or lens, can move in and out of a surface, side to side, and change shape and location, compared to each other and the surface,
(e) where the rear surface includes curved, hyperbolic, parabolic, cycloidal, non uniform, periodic shapes in different areas, and in at least one position substantially behind similar shapes on the outer surface,
(f) where the rear surface contains elements characterized by at least one emitter, receptor, circuit, data storage unit, bump, dot, pixel, tube, optic fiber, or lens, separated from each other by a plurality of non uniform distances, as can the outer surface and anywhere in between,
(g) where the elements characterized by at least one emitter, receptor, data storage unit, bump, dot, pixel, tube, optic fiber, or lens, can be of varying sizes, shapes, orientations a plurality of which are non uniform,
(h) where including emitting or receiving a signal the signal bending and/or reflecting means can vary in focal depth in a non uniform, irregular, periodic pattern in a plurality of positions,
(i) where a plurality of the signal emitting and/or receiving elements are spread unevenly on the inner and outer surface,
(j) where the elements defined herein can contain other elements defined herein on or in them, and so on as deeply as desired, including a periodic, aperiodic, or non uniform pattern,
(k) where any emitter can be replaced by a receptor or vice versa,
(l) where the elements, including at least one emitter, receptor, data storage unit, circuit, bump, dot, pixel, tube, optic fiber, or lens, can be pushed from behind to change shape, and/or be pulled from behind and/or another direction to change shape,
(m) where a plurality of the parts, including at least one emitter, receptor, data storage unit, circuit, bump, dot, pixel, tube, optic fiber, or lens, can contain phosphor, ends of optic fibers, be polarized,
(n) where the elements including at least one emitter, receptor, data storage unit, circuit, bump, dot, pixel, tube, optic fiber, or lens, are directed in irregular orientations statically and/or dynamically,
(o) where at least one of the elements including at least one emitter, receptor, data storage unit, circuit, bump, dot, pixel, tube, optic fiber, or lens, is recessed in a tube,
(p) where the elements, including at least one emitter, receptor, data storage unit, bump, dot, pixel, tube, optic fiber, or lens, can be curved or straight in a predetermined ratio,
(q) where the elements, including at least one emitter, receptor, data storage unit, bump, dot, pixel, tube, optic fiber, or lens, can cross partially or wholly,
(r) where the elements, including at least one emitter, receptor, data storage unit, bump, dots, pixel, tube, optic fiber, or lens, can be of the same or varying sizes in sections of a periodic or aperiodic irregular non uniform pattern.
(s) where the elements, including at least one emitter, receptor, data storage unit, bump, dot, pixel, tube, optic fiber, or lens, can be circular in cross section or any shape, and alter cross section according to a stimulus,
(t) where at least one element, characterized by at least one emitter, receptor, data storage unit, bump, dot, pixel, tube, optic fiber, or lens, can be long and narrow, or short and wide,
(u) where at least one element, characterized as at least one emitter, receptor, data storage unit, bump, dot, pixel, tube, optic fiber, or lens, can move around, change position, and point in different directions on a surface independently or in a predetermined pattern with other elements,
(v) where at least one element, characterized as at least one emitter, receptor, data storage unit, bump, dot, pixel, tube, optic fiber, or lens, can change orientation according to a stimulus,
(w) where at least one element, characterized by at least one emitter, receptor, data storage unit, bump, dot, pixel, tube, optic fiber, or lens, can flex while inside or outside into any shape, changing length, width, depth, becoming straighter or more curved,
(x) where at least one element, characterized by at least one emitter, receptor, bump, dot, pixel, tube, optic fiber, or lens, can scan in a predetermined pattern to receive and/or transmit a signal,
(y) where the elements can be mounted in or on shapes including flat or curved surfaces,
(z) where a signal including a beam can play across the elements, characterized as at least one emitter, circuit, receptor, data storage unit, bump, dot, pixel, tube, optic fiber, or lens, in a predetermined pattern including like an electron gun, inputting a signal, stimulus, and/or other actions.
(aa) where at least one element characterized by at least one emitter, receptor, data storage unit, bump, dot, pixel, tube, optic fiber, or lens, have certain specifications including being empty, hollow,
(bb) where a plurality of elements, including at least one emitter, receptor, data storage unit, bump, dot, pixel, tube, optic fiber, or lens, are composed of a transparent, and/or polarizing material,
(cc) where a plurality of elements, including at least one emitter, receptor, data storage unit, bump, dot, pixel, tube, optic fiber, or lens, can perform a task, including being printed, molded, inserted onto and/or into a surface including paper, cloth, concrete, plastic, metal,
(dd) where a focusing means including a lens can bend light from and/or bend light into at least one such emitter, receptor, data storage units, bump, dot, pixel, tube, optic fiber, or lens,
(ee) where at least one of the elements, including at least one emitter, receptor, data storage unit, bump, dot, pixel, tube, optic fiber, or lens, is stationary and at least one is moving around in a predetermined pattern,
(ff) where at least one element, including at least one emitter, receptor, data storage unit, bump, dot, pixel, tube, optic fiber, or lens, can focus light, sound, radiation, electrons, positrons, magnetic fields, onto the surface of a an element including at least one emitter, receptor, data storage, bump, dot, pixel, tube, optic fiber, or lens,
(gg) where a surface with varying, substantially non uniform patterns can be used to focus including light, sound, electromagnetic radiation, positrons, electrons, magnetic fields,
(hh) where textures can be simulated with a plurality of elements including at least one emitter, receptor, data storage unit, bump, dot, pixel, tube, optic fiber, or lens,
(ii) where the elements including at least one bump, dot, pixel, tube, optic fiber, or lens, can contain an emitter and receptor with a divider between them.

2. A device as claimed in claim 1:
(a) that can have signals including light, electromagnetic radiation, sound, magnetic fields, electrons, positrons, pressure, come through from behind or reflected from the front,
(b) where a screen can contain emitters and/or receptors including of sound, light, electromagnetic radiation, pressure in separate areas and/or a plurality are intermixed in any ratio,
(c) where a plurality of elements including at least one emitter, receptor, data storage unit, circuit, bump, dot, pixel, tube, optic fiber, or lens, can each be or have an overlay of a polarizing material in a predetermined polarizing direction, in a periodic, aperiodic, irregular pattern,
(d) where receptors and emitters in a uniform, periodic or non uniform pattern can emit and receive signals including sonar, vibrations, pressure, data on earth tremors and vibrations, data on fish movements, boat movements, storms, hurricanes,
(e) where the non uniform array of elements including at least one emitter, receptor, data storage unit, circuit, bump, dot, pixel, tube, optic fiber, or lens, in any combination, can emit or receive signals including polarized light, laser light, sound, pressure, all electromagnetic frequencies,
(f) where a phosphor material glows to direct light up at least one of the elements including at least one emitter, receptor, data storage unit, circuit, bump, dot, pixel, tube, optic fiber, or lens, arrayed in a non uniform or periodic pattern in a plurality of positions,
(g) where signals including radar, sound, heat, electrons, positrons, magnetic fields, electromagnetic radiation excluding visible light can be focused with a reflecting and/or refracting means, and/or a parabolic mirror onto a curved focal plane, and where the same array can be an emitter,
(h) where other frequencies of light than red, green, and blue can be emitted and/or received,
(i) where the non uniform array of elements including at least one emitter, receptor, data storage unit, circuit, bump, dot, pixel, tube, optic fiber, or lens, can be combined with elements including at least one colored dot, texture, matt finish, shiny surface, color, grayscale material,
(j) where signals including radar, light, sound, heat, pressure, magnetic fields, electrons, positrons can be emitted from a curved plane onto a reflecting and/or refracting, focusing means and be directed to a predetermined task,
(k) where signals including radar, light, sound, heat, pressure, magnetic fields, electrons, positrons can be emitted from a curved plane through at least one lens and be focused onto a surface.

3. A device as claimed in claim 2:
(a) where the elements including at least one emitter, receptor, data storage unit, circuit, bump, feature, dot, pixel, tube, optic fiber, or lens can direct the emissions on the edges of a display and/or receiver to make a predetermined non uniform or periodic pattern, synchronize with objects including neighboring displays and/or receivers, their edges,
(b) where on the edges of the display and/or receptors, and/or on a plurality of selected sections, the elements including at least one emitter, receptor, data storage unit, circuit, bump, dot, pixel, tube, optic fiber, or lens can make tiled displays and/or receptors connect in a predetermined non uniform or periodic pattern,
(c) where parts including supports and braces can have elements including at least one emitter, receptor, data storage unit, circuit, bump, dot, pixel, tube, optic fiber, or lens, in and/or through them,
(d) where the edge between tiled displays and/or receptors has a predetermined shape including being less visible through a non uniform or periodic pattern of elements in a plurality of positions in the display and/or receptor,
(e) where a non uniform or periodic pattern can also be used for visual effects including in tiling displays and/or receptors,
(f) where a plurality of elements including at least one emitter, receptor, data storage unit, circuit, bump, dot, pixel, tube, optic fiber, or lens are used on or in objects including a display, a helmet, an eyeglass display, a screen, walls of a room, a holodeck, on or in the ground, in the air, in any ratio,
(g) where the elements including at least one emitter, receptor, data storage unit, circuit, bump, dot, pixel, tube, optic fiber, or lens, can be parts of and connected to computer circuitry,
(h) where the elements including at least one emitter, receptor, data storage unit, circuit, bump, dot, pixel, tube, optic fiber, or lens, can make electronic ears and eyes,
(i) where the elements including at least one emitter, receptor, data storage unit, circuit, bump, dot, pixel, tube, optic fiber, or lens, can store data in their shape including their orientation, ratios, densities, and in changes to their structure,
(j) where the elements including at least one emitter, receptor, data storage unit, circuit, bump, dot, pixel, tube, optic fiber, or lens, can contain conduits including wires, optical waveguides in a plurality of non uniform ways,
(k) where objects including walls, chairs, cloth can be covered substantially and interwoven with elements including at least one emitter, receptor, data storage unit, circuit, bump, dot, pixel, tube, optic fiber, or lens that are non uniform and/or periodic in a plurality of places,
(l) where cloth can be made of elements including at least one emitter, receptor, data storage unit, circuit, bump, dot, pixel, tube, optic fiber, or lens,
(m) where connections between parts of the elements including at least one emitter, receptor, data storage unit, circuit, bump, dot, pixel, tube, optic fiber, or lens are by wires, optic fiber, tubes, signals by light, sound, electrons, positrons, magnetic fields, and are regulated by circuitry,
(n) where a periodic pattern of lenticular lenses or barriers to emit a 3D image is excluded as a periodic pattern herein,
(o) where fixed, non flexing glass columns extending from the surface in a uniform pattern to emit a 3D image are excluded.

4. A device:
A 2D/3D system:
(a) where the receiving and/or emitting elements including at least one emitter, receptor, data storage device, circuit, bump, dot, pixel, tube, optic fiber, or lens, mirror, polarized element, textured element can be glued, attached, connected onto and/or into a surface, fabric, printed page, inserted onto and/or into a printed, cloth, moldable surface, to create and/or receive a 2D/3D image,
(b) where the deformable materials used can include concrete, paper, plastic, that can be molded,
(c) where additionally elements including at least one emitter, receptor, data storage unit, circuit, bump, dot, pixel, tube, optic fiber, or lens can be molded with materials including plastic, metal, concrete, paper into place and printed shapes including dots added,
(d) where elements including at least one emitter, receptor, data storage unit, circuit, bump, dot, pixel, tube, optic fiber, or lens, on and in the surface can be rotated, reoriented, relocated to preferred positions to create and/or receive a 2D/3D image,
(e) where the elements including at least one emitter, receptor, data storage unit, circuit, bump, dot, pixel, tube, optic fiber, or lens, can be etched and polarized in a plurality of non uniform positions and specifications, with any other objects defined in these claims in a periodic or uniform set of positions and specifications to create and/or receive a 2D/3D image,
(f) that can be disassembled into sections, each section with uses including as a 2D/3D display with a plurality of non uniform specifications in its elements, and where a plurality of 2D/3D displays and/or receptors can be assembled together to make a larger screen with a plurality of non uniform characteristics,
(g) where the objects as defined anywhere in these claims can contain or adjoin other such objects and other such elements in or on them, and so on as deeply as desired, and also they can overlap in a 2D/3D emitter and/or receptor,
(h) where the 2D/3D display and/or receptor has rotating elements including at least one rotating circuit, rotating element, rotating tube, rotating pixel, rotating bump, rotating lens, rotating mirror, rotating fiber, and rotating means any trajectory, direction, shape, curve,
(i) where display sources including liquid crystal displays and Cathode Ray Tube displays can be used to supply images to the 2D/3D display and/or receptor,
(j) where receptors including film, CCD's can be used as receptors,
(k) where the elements including at least one emitter, receptor, data storage unit, circuit, bump, dot, pixel, tube, optic fiber, or lens can be solid, hollow, flexible, contain materials including wires, solids, liquids,
(l) where the surface can be an irregular, periodic wave like pattern or shape,
(m)where the data received in association with the 2D/3D device can be stored in a 3D pattern in a storage device,
(n) where pressure can applied from below and/or above to change the shape of the elements including at least one emitter, receptor, data storage unit, circuit, bump, dot, pixel, tube, optic fiber, or lens,
(o) where the non uniform pattern of a plurality of elements including at least one emitter, receptor, data storage unit, circuit, bump, dot, pixel, tube, optic fiber, or lens in their orientation can give a particular image, use, effect,
(p) where textures including etched parts of the surface in a plurality of non uniform positions can assist in the storing of data, receiving and/or emitting signals,
(q) where at least one tube on and in the front and/or rear surface or other surface can change including altering orientation, shape, position, cross section while emitting and/or receiving image, data, sounds, radiation recording data, images,
(r) where a plurality of non uniform elements in a 3D pattern can act as a barrier to view from some directions,
(s) where a plurality of the light bending and reflecting elements in a 2D/3D display and/or receptor can have a non uniform, periodic or aperiodic pattern,
(t) where a plurality of the lenses, focusing means have a different focal length, width, size, shape, and a differing focal plane shape,
(u) where a plurality of the rear and other surface areas have an irregular, non uniform, aperiodic, periodic, curved, cycloidal, parabolic, hyperbolic, slanted surface,
(v) where the emitters and/or receptors have a plurality of irregular locations, sizes, distances, shapes between them.
(w) where the walls of a building including a cinema can be covered with 3D screens, arranged on each wall,
(x) where the emitters and/or receptors can be in the shape of a part or whole of a shape including a cylinder on the inner and/or outer surface,
(y) where two or more focusing means including lenses, can focus onto an element including at least one emitter, receptor, data storage unit, circuit, bump, dot, pixel, tube, optic fiber, or lens, in a non uniform array and record and/or display a stereoscopic picture.

5. A device as claimed in claim 4:
(a) where it emits and/or receives, records and/or plays back including with light, sound, electrons, radar, sonar, low frequency waves, pressure, electrons, positrons, data, magnetic fields,
(b) which can emit a first sound signal to attenuate a second sound signal by emitting that first sound signal in a 3D array including to substantially mimic the waves of the second sound signal, but out of phase to reduce its volume,
(c) that can emit and receive 3D sounds of all frequencies in a directed manner in a 3D way, including of electromagnetic radiation and/or sound,
(d) where the elements including at least one emitter, receptor, data storage unit, circuit, bump, dot, pixel, tube, optic fiber, or lens are arrayed to emit and/or receive a 2D/3D signal,
(e) where at least one emitter, receptor, data storage unit, bump, dot, pixel, tube, optic fiber, or lens can emit and/or receive changes in variables including heat, decay, time dilations, color changes, pressure,
(f) where the 2D/3D display and/or receptor includes rotating colored balls, which can show different patterns in different directions,
(g) where including light, positrons, electrons, magnetic fields can be emitted and/or received, and the data to and from the elements including at least one emitter, receptor, data storage unit, circuit, bump, dot, pixel, tube, optic fiber, or lens can be emitted and/or received,
(h) where a projector can emit a first signal onto the screen to cause a plurality of elements including at least one emitter, receptor, data storage unit, circuit, bump, dot, pixel, tube, optic fiber, or lens in a non uniform or periodic array to emit a second signal.

6. A device as claimed in claim 5:
(a) where the display and/or receptor can include a wall hanging, any kind of display shape known in the art, furniture covering,
(b) where a display and/or receptor can include being circular, spherical, cylindrical, periodic, irregular in at least one section,
(c) where an object of a first shape with a 3D array of emitters and/or receptors on it transfers a signal to and/or from an object of a second shape with a 3D array of emitters and/or receptors on it,
(d) where a laser can be reorientated and remodulated in response to a stimuli including radio waves, to emit a signal onto the inside of an object, sphere, with a plurality of receptors on or in its inner surface and those signals can be transferred to a device including a display, storage, conduit, tube,
(e) where the signal can include data, imagery,
(f) where the signal can include the characteristics of being analogue or digital and vary in ranges including brightness, loudness, contrast, color,
(g) where the waves can be many kinds including coherent, incoherent, digital,
(h) where the elements can form a tactile display in a plurality of non uniform areas in the distances, size, shape, width, depth between the elements including at least one emitter, receptor, data storage unit, circuit, bump, dot, pixel, tube, optic fiber, or lens.

7. A device as claimed in claim 6:
(a) that can be placed in any shape around at least one object, in conjunction with receptors including cameras, CCD's to determine the scenery and objects around it, to display a 3D image so as to make the object appear substantially or wholly invisible, transparent, cloaked, from predetermined angles,
(b) that uses a combination of 3D emitters and/or receptors using any 3D process known to the art to make an object appear in a predetermined way including transparent, invisible, cloaked,
(c) to make the object covered substantially by a combination of 3D emitters and/or receptors appear to be at least one different object and other parts to appear different including substantially transparent, invisible, cloaked,
(d) where including sound, radar, electromagnetic radiation can be altered including attenuated, cancelled out, reconstituted to include making the object appear substantially transparent, opaque to these, and/or to substantially replace these signals with a different signal,
(e) where a combination of 3D emitters and/or receptors can make an object appear to be substantially transparent, invisible, cloaked to including electromagnetic radiation, visible light, infra red radiation, radar, sonar, and/or to present a 3D image of at least one object in including electromagnetic radiation, visible light, sound, infra red, radar, sonar, pressure,
(f) where a substantially or wholly transparently appearing combination of 3D emitters and/or receptors also displays a less transparent or opaque image, to create the partial appearance of including transparency, invisibility, cloaking, mimicry,
(g) where a first 3D image can be partially transparent to overlay the first image on a second 3D image, such images can include scenery, data, computer graphics, to create the appearance of including transparency, invisibility, cloaking, mimicry,
(h) where individual elements including at least one emitter, receptor, data storage unit, circuit, bump, dot, pixel, tube, optic fiber, or lens, are affixed, inserted, attached, molded to make a 3D image to create the appearance of including transparency, invisibility, cloaking, mimicry,
(i) where connections between parts of the elements including at least one emitter, receptor, data storage unit, circuit, bump, dot, pixel, tube, optic fiber, or lens are by devices including wires, optic fiber, tubes, and are regulated by circuitry to create the appearance of including transparency, invisibility, cloaking, mimicry,
(j) where the elements can have characteristics including moving in and out and around, change shape to create the appearance of transparency, invisibility, cloaking, mimicry,
(k) where the emitters and receptors can be mixed together in any ratio, in a periodic, aperiodic, uniform pattern to include creating the appearance of transparency, invisibility, cloaking, mimicry,
(l) where multiple image screens can have image data transferred to a single combination of 3D emitters and/or receptors,
(m) where the 3D elements can contain other elements and other elements in them, and so on as deeply as desired, to include creating the appearance of transparency, invisibility, cloaking, mimicry,
(n) which can be wrapped around or formed on objects of any shape including a sphere, cylinder, a partial cylinder inside or outside, a chair, walls of a room,

8. A device:
(a) A 3D surface used as a data storage medium including in hard drives, optical discs, storage devices,
(b) where the shape of the surface including an uneven, irregular, topography can be altered including being created, written to, read from and viewed as data,
(c) where the shape varies in 3 dimensions instead of 2 like in CD's and DVD's,
(d) where the surface can be altered by a device including a CD burner to create and/or alter the surface in a non uniform 3D pattern,
(e) where the surface can be of a storage device including a hard drive or optical disc material, of materials used in a 3D display,
(f) where the surface can alter in characteristics including shape, reflectivity, magnetization, charge, in response to including stimuli, pressure, light, sound, magnetic fields, positrons, electrons,

9. A device as claimed in claim 8:
(a) where elements substantially on or in the surface of the storage medium can make a predetermined action including recording, reflecting, emitting signals, waves including magnetic fields, electrons, positrons, light, sound, electromagnetic radiation, data,
(b) where the device can include sensors, receptors imbedded and/or emitters,
(c) where the actions on the surface can include to be recorded on and/or read from by multiple sensors,
(d) where a plurality of including tubes, wires, can connect to a plurality of including emitters and/or receptors, record and/or playback heads, lasers, that read and/or write to the 3D storage surface,
(e) where the 3D storage surface can move including spinning, moving forwards and backwards, moving a first direction then a second direction,
(f) where the surface can be made into any 3D shape,
(g) where the surface can be altered in topography to create any kind of reflective and refractive pattern in 3D by a stimulus,
(h) where the characteristics including transparency, refractive and reflective properties of the surface can be altered by an altering means including a CD burner, a stimulus to make a non uniform 3D pattern, to change including to remove, alter, erase data,
(i) where the 3D surface can be changed including to be magnetized at a plurality of points to record and playback data,

10. A device as claimed in claim 9:
(a) where tubes connect to nodes, where nodes contain circuits, 3D wiring, recording and/or playback, and data transfer,
(b) where nodes can change including move about, in and out of an object, alter shape,
(c) where nodes can be viewed, including be accessed by a plurality of including sensors, viewpoints, receptors,
(d) where nodes can emit and/or receive including sound, light, heat, electromagnetic radiation, pressure, to and from preferred directions,
(e) where at least one node has at least one tube, wire, optic fiber connected,
(f) where nodes can act including block, close off, alter, let preferred signals, materials, gases, liquids, pass through them to other nodes, to including a circuit, receptor, emitter,
(g) where viewers cause nodes to open parts of themselves including some facets and close other facets,
(h) where viewers can include mechanical devices or human,
(i) where the nodes can contain and/or be part of Boolean logic circuits,
(j) where operations in and between nodes can include erasure, calculation
(k) where all group theory patterns can be created in switching,
(l) where the array can be reconfigured in real time,
(m) where some dimensions, views are common to a plurality of viewers and some are unique to a viewer,
(n) where the viewer is replaced, augmented including by a mechanical device at times,
(o) where data is stored including in a multidimensional lattice,
(p) where nodes can alter their configuration including to create specialized circuits, improve their connection, optimize circuits,
(q) where data on connections between nodes is stored including in a 3D lattice,
(r) where all kinds of circuits known in the art can be used herein,
(s) where tasks can be broken up into sub tasks to be done by specialized arrays of nodes,
(t) where nodes can be constructed including being molded of plastic, concrete, paper, metal, and additional elements added,
(u) where nodes can contain 3D imaging and/or playback devices, 3D wiring,
(v) where viewers can include operating in pairs and higher numbers coordinated together,
(w) where nodes have at least one facet,

11. A device as claimed in claim 10,
(a) where tubes are used including in circuitry to conduct signals including optical and/ or electric between nodes, connectors,
(b) where tubes are used to channel light including to and from a display surface,
(c) where tubes are used to channel data including to and from a storage surface,
(d) where tubes can intersect each other partially or wholly including to transmit a signal,
(e) where the tubes can contain polarizing material,
(f) where the tubes can contain transparent material or be hollow,
(g) where the tubes can contain wires,
(h) where the tubes can connect to circuitry,
(i) where the tubes can change including flexing and moving, in and out of a surface in response to a stimuli,
(j) where the tubes can be deployed including be woven together like a cloth, rope,
(k) where the tubes including hollow or filled can be used as wires in any kind of circuitry,
(l) where the tubes can be any size, shape, cross section,
(m) where the hollow tubes can join other hollow tubes,
(n) where a lattice, array of tubes includes use in a form of RAM,
(o) where hollow or filled tubes can be used in including long term memory, random access memory, 3D memory,
(p) where the tubes can contain gases, vacuum, liquids, solids, circuitry,
(q) where the tubes are regulated in circuits including by a computer clock,
(r) where tubes can receive and/or emit a signal of including sound, pressure, light, lasers, electromagnetic radiation, electrons, positrons, sonar, radar,
(s) where a first viewer can input data at a first point in the lattice and a second viewer can view it at a second point,
(t) where the lattice of tubes, wires, connectors can be a uniform, periodic or non uniform array,

12. A device as claimed in claim 11,
(a) where a signal emitter and/or receiver including at least one light beam, laser beam, data, sound waves, beam of electrons, beam of positrons, a magnetic field, beam of electromagnetic radiation can be directed including deflected, reflected, focused across the ends of including tubes, optic fibers, lenses in a predetermined pattern sequentially to transfer data to and/or from a display and/or receptor,
(b) where a plurality of emitters, receptors, lasers, electron guns, lights, sounds, electrons, positrons, magnetic fields can be directed onto and/or into the ends of devices including tubes, optic fibers, lenses in a predetermined pattern to transfer signals to and/or from an image emitter and/or receiver,
(c) where a signal emitter and/or receptor can move including rotate, alter orientation, vibrate, oscillate, according to a stimulus to direct a signal on the tube, optic fiber ends in a predetermined pattern to transfer a signal to and/or from a display and/or receptor,
(d) where a deflecting means can move including oscillate, vibrate, alter orientation according to a stimulus to move and/or receive at least one signal including a light beam, laser beam, sound waves, beam of electrons, beam of positrons, a magnetic field, beam of electromagnetic radiation in a predetermined pattern across and/or into and/or out of a device including a tube, optic fiber, emitter, receptor, lens, mirror to transfer a signal to and/or from a display and/or receptor.
(e) where the signal can be modulated by a system in which at least three polarized shapes including plates are set, the two outer at substantially 90 degrees polarity to each other, and at least one plate moves including by rotation relative to the other plate or plates to modulate a signal of including electromagnetic radiation, light passing through it, and the central plate polarization can be changed including removed to alter the signal, and where other devices including liquid crystals can be used as well as or instead of the plates,
(f) Where reflectors and/or refractors, mirrors and/or lenses are moved including vibrated, moved, altered in shape, changed in orientation to move at least one signal including a laser beam, light beam, sound waves, magnetic field, over a screen in a predetermined pattern to form an image,
(g) where the signal including a laser, light, sound, magnetic field can make the display surface glow, emit a second signal, stimulate a response from at least one element on or in the screen,

13. A Device as claimed in claim 12:
(a) where data is arranged in higher than 3, 4 dimensions and can be displayed in groups of 2, 3, 4 and higher numbers of dimensions,
(b) where a first plurality of dimensions are worked with and then a second plurality of dimensions are observed, worked with,
(c) where programs including games, operating systems, file managers, databases, spreadsheets, can be made of environments in higher than 4 dimensions and where one can sequentially look at and interact with a subset of those dimensions, and which can also use the 2D and 3D surfaces described herein to be viewed on,
(d) where the devices including logic circuits can act in higher dimensions,
(e) where points on or in the surface of the display and/or receptor are calculated to find the angle the signal must exit or enter the surface element, and where no single element is in the desired position, orientation, the signal may be averaged according to an algorithm over a plurality of elements,
